(19) United States
(12) Patent Application Publication
(10) Pub. No.: US 2025/0245414 A1
(43) Pub. Date: Jul. 31, 2025

(54) METHOD AND SYSTEM FOR GENERATING ADAPTIVE POWER DELIVERY NETWORK IN INTEGRATED CIRCUIT LAYOUT DIAGRAM

(71) Applicant: TAIWAN SEMICONDUCTOR MANUFACTURING COMPANY LTD., HSINCHU (TW)

(72) Inventors: WEN-HAO CHEN, HSIN-CHU CITY (TW); MING-CHI CHEN, HSINCHU CITY (TW); KUO-NAN YANG, HSINCHU CITY (TW); YI-KAN CHENG, TAIPEI (TW); CHUN-YAO KU, TAIPEI CITY (TW)

(21) Appl. No.: 18/736,596

(22) Filed: Jun. 7, 2024

Related U.S. Application Data
(60) Provisional application No. 63/627,751, filed on Jan. 31, 2024.

(51) Int. Cl. G06F 30/398; G06F 30/392

(52) U.S. Cl. CPC G06F 30/398; G06F 30/392

(57) ABSTRACT

The present disclosure provides a method, which includes the following steps: obtaining a netlist of an integrated circuit (IC) design; performing an automatic placement and routing (APR) process on the netlist to generate a result layout diagram; and during each operation with the APR process, refining, using a machine-learning model, a power delivery network within a layout diagram generated at each operation within the APR process.

### CROSS-REFERENCE TO RELATED APPLICATION(S)

This application claims the benefit of U.S. Provisional Application No. 63/627,751, filed Jan. 31, 2024, the entire disclosure of which is incorporated by reference herein.

### BACKGROUND

The semiconductor integrated circuit (IC) industry has experienced exponential growth. In semiconductor IC design, standard cell methodologies are commonly used for the design of semiconductor devices on a chip. Standard cell methodologies use standard cells as abstract representations of certain functions to integrate millions of devices on a single chip. As ICs continue to scale down, more and more devices are integrated into a single chip. This scaling down process generally provides benefits by increasing production efficiency and lowering associated costs.

### BRIEF DESCRIPTION OF THE DRAWINGS

Aspects of the present disclosure are best understood from the following detailed description when read with the accompanying figures. It is emphasized that, in accordance with standard practice in the industry, various features are not drawn to scale. In fact, the dimensions of the various features can be arbitrarily increased or reduced for clarity of discussion.

FIG. 1 is a block diagram of an IC design system 100 in accordance with some embodiments.

FIG. 2 is a functional flow chart of at least a portion of an IC design flow 200 in accordance with some embodiments of the present disclosure.

FIG. 3 is a flowchart of the training procedure of the machine-learning model to generate an adaptive power delivery network in an integrated circuit in accordance with some embodiments of the present disclosure.

FIGS. 4A to 4J are diagrams of different PDN (power delivery network) structures in accordance with some embodiments of the present disclosure.

FIG. 5 is a diagram illustrating different layers on the frontside and backside of a semiconductor substrate in accordance with some embodiments of the present disclosure.

FIG. 6A is a flowchart of the inference procedure of a machine-learning model in accordance with some embodiments of the present disclosure.

FIG. 6B is a diagram illustrating the inference procedure of the machine-learning model in FIG. 6A.

FIG. 7 is a flowchart of the procedure of constructing an adaptive frontside PDN within an IC layout diagram during various operations in an APR process, in accordance with some embodiments of the present disclosure.

FIGS. 8A to 8D are different perspective views of layout diagrams during different operations in flow 700 of FIG. 7.

FIG. 9 is a flowchart of the procedure of constructing an adaptive backside PDN within an IC layout diagram during various operations in an APR process, in accordance with some embodiments of the present disclosure.

FIGS. 10A to 10D-3 are different perspective views of layout diagrams during different operations in flow 900 of FIG. 9.

FIG. 11 is a flowchart of the procedure of constructing an adaptive dual-side PDN within an IC layout diagram during various operations in an APR process, in accordance with some embodiments of the present disclosure.

FIGS. 12A-1 to 12D-3 are different perspective views of layout diagrams during different operations in flow 1100 of FIG. 11.

FIG. 13 is a flowchart of the procedure of constructing an optimal frontside PDN within an IC layout diagram in an APR process in accordance with some embodiments of the present disclosure.

FIGS. 14A to 14D are different perspective views of layout diagrams during different operations in flow 1300 of FIG. 13.

FIG. 15 is a cross section of a semiconductor structure in accordance with some embodiments of the present disclosure.

FIG. 16 is a block diagram of an IC manufacturing system, and an IC manufacturing flow associated therewith, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features can be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Further, it will be understood that when an element is referred to as being “connected to” or “coupled to” another element, it can be directly connected to or coupled to the other element, or intervening elements can be present.

Embodiments, or examples, illustrated in the drawings are disclosed as follows using specific language. It will nevertheless be understood that the embodiments and examples are not intended to be limiting. Any alterations or modifications in the disclosed embodiments, and any further applications of the principles disclosed in this document are contemplated as would normally occur to one of ordinary skill in the pertinent art.

Further, it is understood that several processing steps and/or features of a device can be only briefly described. Also, additional processing steps and/or features can be added, and certain of the following processing steps and/or features can be removed or changed while still implementing the claims. Thus, it is understood that the following descriptions represent examples only, and are not intended to suggest that one or more steps or features are required.

In addition, the present disclosure may repeat reference numerals and/or letters in the various examples. This repetition is for the purpose of simplicity and clarity and does not in itself dictate a relationship between the various embodiments and/or configurations discussed.

In integrated circuit (IC) design, a variety of functions are integrated into one chip, and an application specific integrated circuit (ASIC) or system on a chip (SOC) cell based design is often used. In this approach, a library of known functions is provided, and after the functional design of the device is specified by choosing and connecting these standard functions, and proper operation of the resulting circuit is verified using electronic design automation (EDA) tools, the library elements are mapped on to predefined layout cells, which contain prefigured elements such as transistors. The cells are chosen with the particular semiconductor process nodes and parameters in mind and create a process-parameterized physical representation of the design. The design flow continues from that point by performing placement and routing of the local and global connections needed to form a layout of the completed design using the standard cells.

After the layout is completed, various analysis procedure are performed and the layout is verified to check whether the layout violates any of the various constraints or rules. For example, design rule check (DRC), layout versus schematic (LVS) and electric rule check (ERC) are performed. The DRC is a process of checking whether the layout is successfully completed with a physical measure space according to the design rule, and the LVS is a process of checking whether the layout meets a corresponding circuit diagram. In addition, the ERC is a process of for checking whether devices and wires/nets are electrically well connected therebetween. After design rule checks, design rule verification, timing analysis, critical path analysis, static and dynamic power analysis, and final modifications to the design, a tape out process is performed to produce photomask generation data. This photomask generation (PG) data is then used to create the optical masks used to fabricate the semiconductor device in a photolithographic process at a wafer fabrication facility (FAB). In the tape out process, the database file of the IC is used to make various layers of masks for integrated circuit manufacturing. In some embodiments, the database file is a Graphic Database System (GDS) file (e.g., a GDS file or a GDSII file). Furthermore, the GDS file is the industry's standard format for transfer of IC layout data between design tools of different vendors.

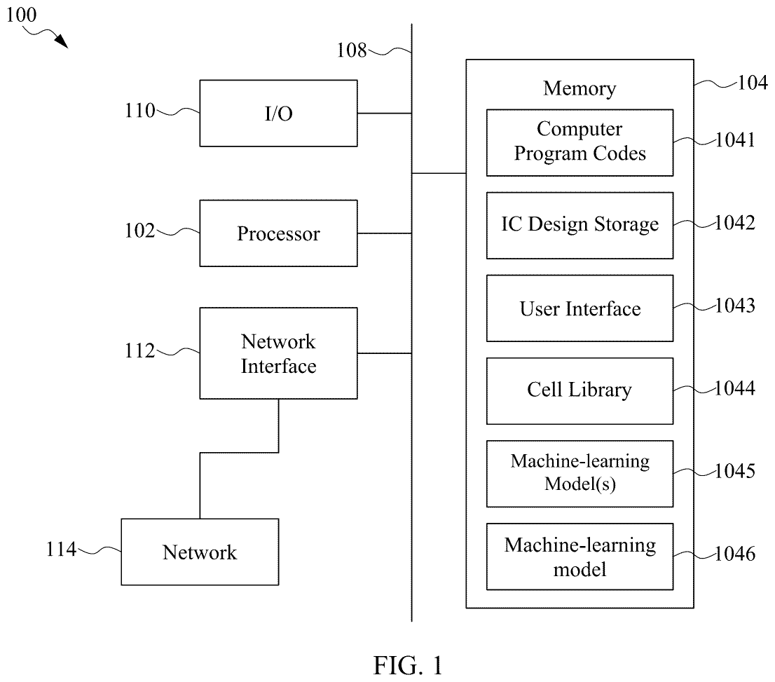

FIG. 1 is a block diagram of an IC design system 100 in accordance with some embodiments. Methods described herein for designing IC layout diagrams and adaptively generating power delivery networks in accordance with one or more embodiments are implementable, for example, using IC design system 100, in accordance with some embodiments. In some embodiments, IC design system 100 is an APR (automatic placement and routing) system, includes an APR system, or is part of an APR system, usable for performing an APR method.

In some embodiments, IC design system 100 is a general purpose computing device including a hardware processor 102 and memory 104. Memory 104 is a non-transitory, computer-readable storage medium. Memory 104, amongst other things, is encoded with, i.e., stores, computer program codes 1041, i.e., a set of executable instructions. Execution of computer program codes 1041 by hardware processor 102 represents (at least in part) an EDA tool which implements a portion or all of a method, e.g., flows 200, 300, 700, 900, 1100, and 1300 described later (hereinafter, the noted processes and/or methods).

Processor 102 is electrically coupled to memory 104 via bus 108. Processor 102 is also electrically coupled to an I/O interface 110 through bus 108. Network interface 112 is also electrically connected to processor 102 through bus 108. Network interface 112 is connected to a network 114, so that processor 102 and memory 104 are capable of connecting to external elements via network 114. Processor 102 is configured to execute computer program codes 1041 encoded in memory 104 in order to cause IC design system 100 to be usable for performing a portion or all of the noted processes and/or methods. In one or more embodiments, processor 102 is a central processing unit (CPU), a multi-processor, a distributed processing system, an application specific integrated circuit (ASIC), and/or a suitable processing unit, but the present disclosure is not limited thereto.

In one or more embodiments, memory 104 is an electronic, magnetic, optical, electromagnetic, infrared, and/or a semiconductor system (or apparatus or device). For example, memory 104 may be or include a non-volatile memory such as a semiconductor or solid-state memory, a hard disk drive (HDD), a magnetic tape, a removable computer diskette, a random access memory (RAM), a read-only memory (ROM), a rigid magnetic disk, an optical disk, SD memory card, memory sticks, ferroelectric random access memory (FeRAM), resistive random access memory (RRAM), etc., but the present disclosure is not limited thereto. In one or more embodiments using optical disks, memory 104 includes a compact disk-read only memory (CD-ROM), a compact disk-read/write (CD-R/W), and/or a digital video disc (DVD).

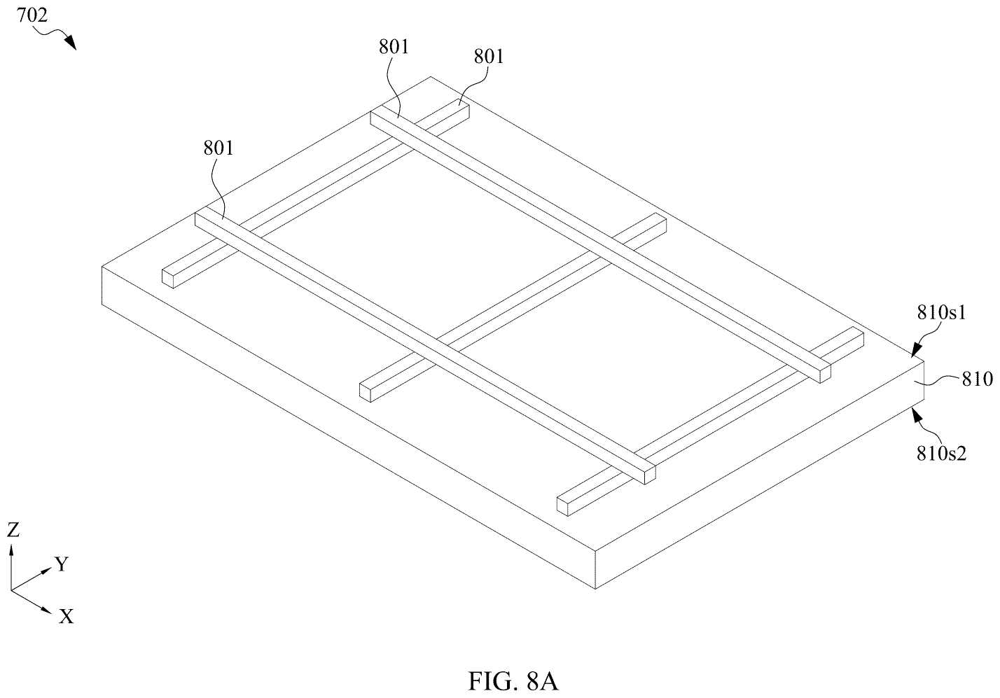

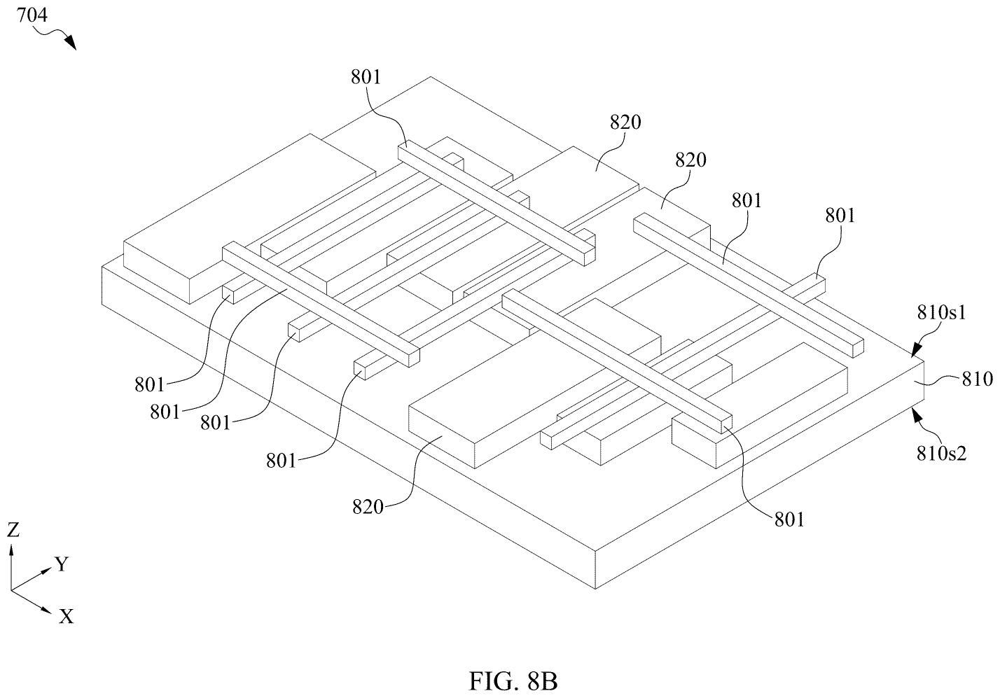

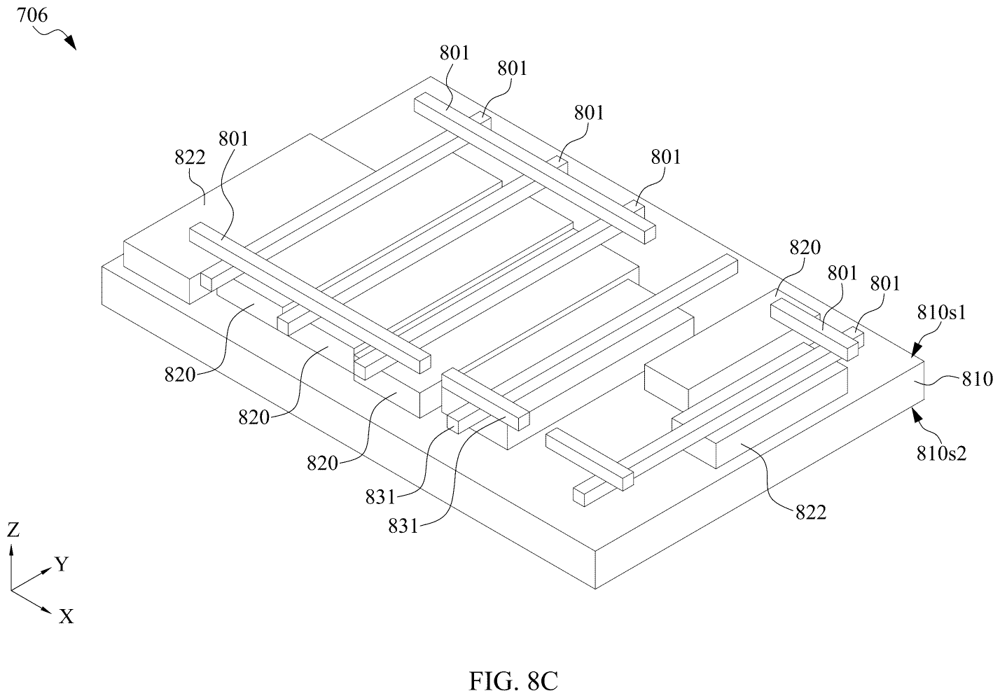

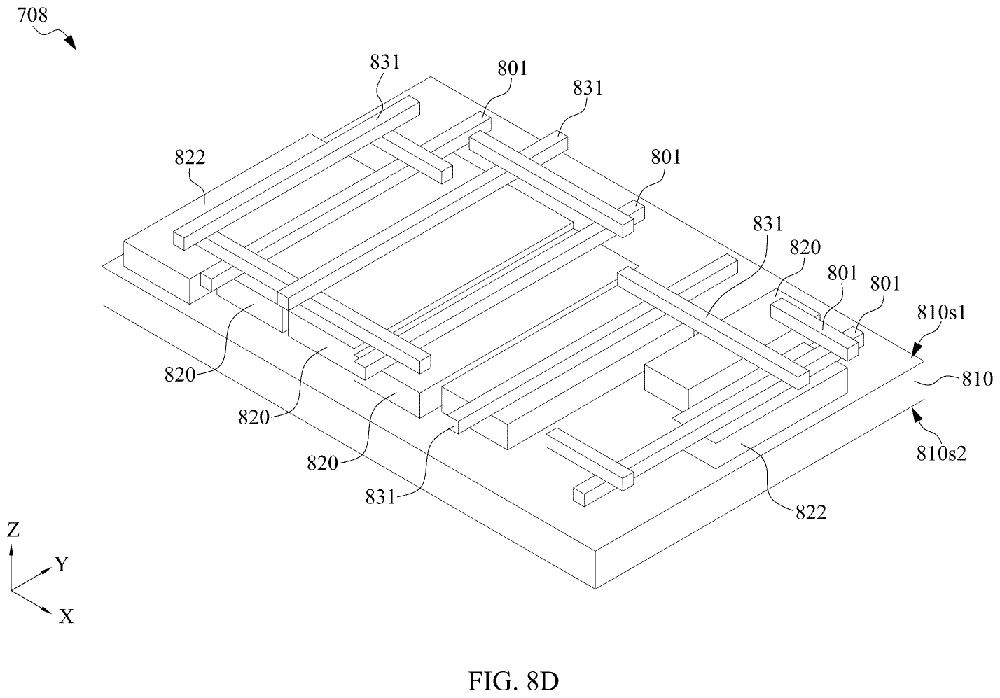

In one or more embodiments, memory 104 stores computer program codes 1041 configured to cause IC design system 100 (where such execution represents (at least in part) the EDA tool) to be usable for performing a portion or all of the noted processes and/or methods. In one or more embodiments, memory 104 also stores information which facilitates performing a portion or all of the noted processes and/or methods. In one or more embodiments, memory 104 includes IC design storage 1042 configured to store one or more IC layout diagrams, e.g., an IC layout diagram 702-708, 902-908, 1102-1108, 1400A-1400D discussed later with respect to FIGS. 8A-8D, 10A-10D, 12A-12D, and 14A-14D.

IC design system 100 includes I/O interface 110. I/O interface 110 is coupled to external circuitry. In one or more embodiments, I/O interface 110 includes a keyboard, keypad, mouse, trackball, trackpad, touchscreen, and/or cursor direction keys for communicating information and commands to processor 102.

In some embodiments, IC design system 100 also includes network interface 112 coupled to processor 102. Network interface 112 allows IC design system 100 to communicate with network 114, to which one or more other computer systems are connected. In some embodiments, network interface 112 includes wireless network interfaces and/or wired network interface. The wireless network interface may include Wi-Fi (802.11), Global System for Mobile Communications (GSM), Enhanced Data rates for GSM Evolution (EDGE), Wideband Code Division Multiple Access (WCDMA), Time Division-Synchronous Code Division Multiple Access (TD-SCDMA), Long Term Evolution (LTE), 4-th Generation (4G), 5-th Generation (5G), 6-th Generation (6G), ultra-wideband (UWB), infrared (IR) protocols, near field communication (NFC) protocols, Wibree, Bluetooth protocols, wireless Universal Serial Bus (USB) protocols, etc. The wired network interfaces may include Ethernet, Universal Serial Bus (USB), Inter Integrated Circuit (I2C), Serial Peripheral Interface (SPI), etc., but the present disclosure is not limited thereto. In one or more embodiments, a portion or all of noted processes and/or methods, is implemented in two or more IC design systems 100.

In some embodiments, IC design system 100 is configured to receive information through I/O interface 110. The information received through I/O interface 110 includes one or more of instructions, data, design rules, libraries of standard cells, and/or other parameters for processing by processor 102. The information is transferred to processor 102 via bus 108. IC design system 100 is configured to receive information related to a user interface through I/O interface 110. The information is stored in memory 104 as user interface (UI) 1043.

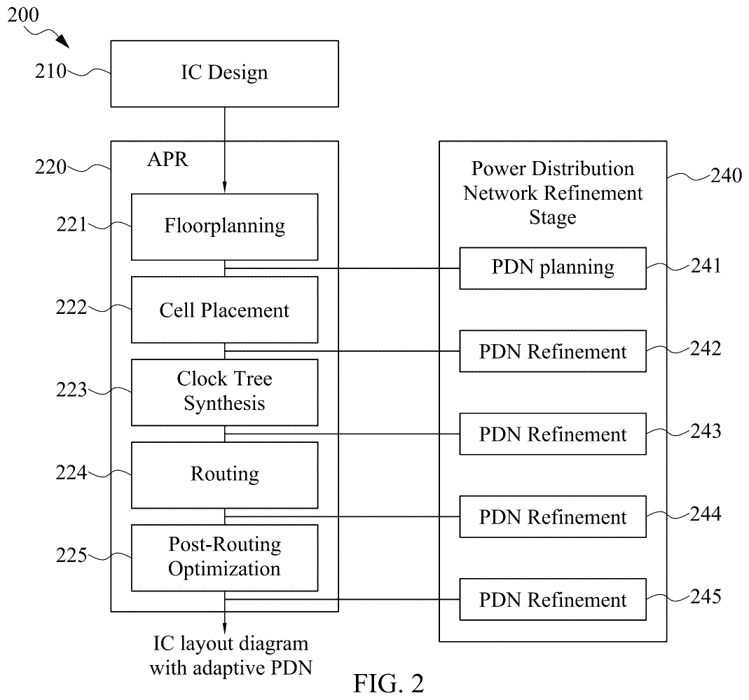

In some embodiments, the cell library 1044 may be configured to store a plurality of standard cells and/or circuit elements that can be used in an APR process. In some embodiments, the machine-learning model 1045 may be configured to generate an adaptive power delivery network on a frontside, a backside, or dual sides (i.e., including both the frontside and backside) of a semiconductor substrate on a power-grid basis. For example, the processor 102 may execute the machine-learning model 1045 to adaptively modify the power delivery network, which can be a frontside, backside, or dual-side PDN, on the layout diagram after each operation or stage within an APR process, which may include floorplanning, cell placement, clock tree synthesis, routing, post-routing optimization, etc. Further details will be described in the following embodiments with respect to FIGS. 2 to 14.

In some embodiments, the machine-learning model 1046 may be configured to generate an optimal frontside power delivery network on the frontside of a semiconductor substrate based on one or more design parameters of a given IC layout diagram.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by IC design system 100. In some embodiments, a layout diagram which includes standard cells is generated using a tool such as VIRTUOSO® available from CADENCE DESIGN SYSTEMS, Inc., or another suitable layout generating tool.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

IC Design Flow with Power Delivery Network Refinement Stage

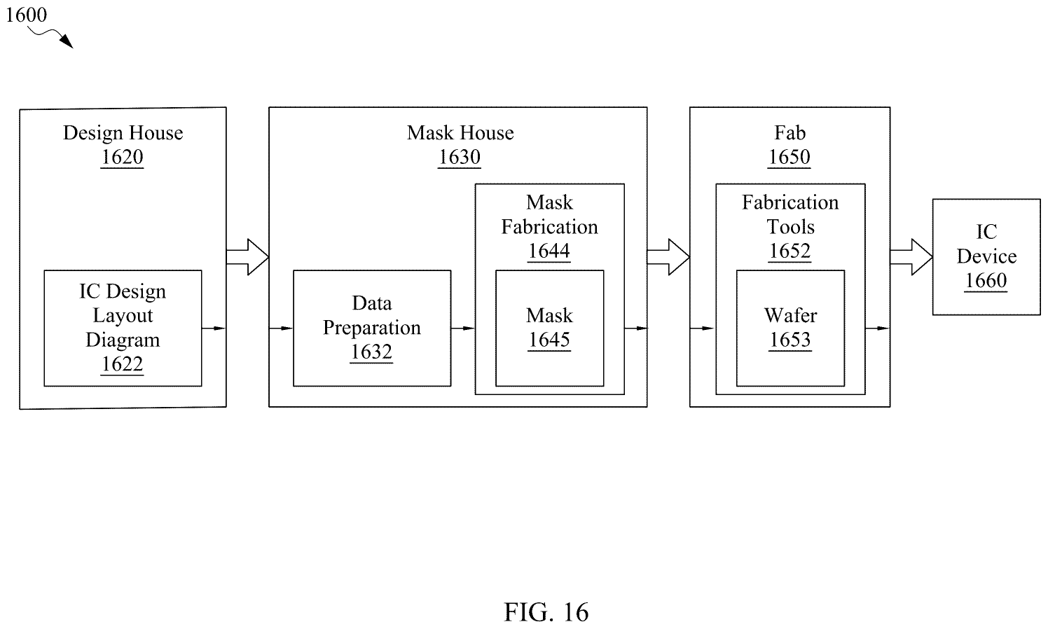

FIG. 2 is a functional flow chart of at least a portion of an IC design flow 200 in accordance with some embodiments of the present disclosure. The design flow 200 utilizes one or more electronic design automation (EDA) tools (e.g., computer program codes 1041) for generating, optimizing and/or verifying a design of an IC before manufacturing the IC. The EDA tools, in some embodiments, are one or more sets of executable instructions for execution by a processor (e.g., processor 102) or controller or a programmed computer to perform the indicated functionality. In at least one embodiment, the IC design flow 200 is performed by a design house of an IC manufacturing system discussed herein with respect to FIG. 16.

At IC design operation 210, a design of an IC is provided by a circuit designer. In some embodiments, the design of the IC comprises an IC schematic, i.e., an electrical diagram, of the IC. In some embodiments, the schematic is generated or provided in the form of a schematic netlist, such as a Simulation Program with Integrated Circuit Emphasis (SPICE) netlist. Other data formats for describing the design are usable in some embodiments. In some embodiments, a pre-layout simulation is performed on the design to determine whether the design mects a predetermined specification. When the design does not meet the predetermined specification, the IC is redesigned. In at least one embodiment, a pre-layout simulation is omitted.

In some embodiments, the processor 102 may execute one or more computer program codes (e.g., EDA tools or APR tools) to perform an APR process to build a layout diagram of an IC design. The APR process may include operations 202, 206, 210, 214, and 218, namely, floorplanning, cell placement, clock tree synthesis, routing, post-routing optimization, respectively.

At Automatic Placement and Routing (APR) operation 220, a layout diagram of the IC is generated based on the IC schematic. The IC layout diagram comprises the physical positions of various circuit elements of the IC as well as the physical positions of various nets interconnecting the circuit elements. For example, the IC layout diagram is generated in the form of a Graphic Design System (GDS) file. Other data formats for describing the design of the IC are within the scope of various embodiments. In the example configuration in FIG. 2, the IC layout diagram is generated by an EDA tool, such as an APR tool. The APR tool (e.g., computer program codes 1041) receives the design of the IC in the form of a netlist as described herein. In the example configuration in FIG. 2, the APR tool performs floorplanning operation 221, cell placement operation 222, clock tree synthesis operation 223, routing operation 224, and post-routing optimization operation 225. Additionally, the APR operation 220 is performed collaboratively with PDN refinement stage 240 which includes PDN planning operation 241 and PDN refinement operations 242 to 245. In some embodiments, the PDN refinement stage 240 can be performed by the machine-learning model 1045 shown in FIG. 1, thereby refining the PDN within the layout diagram generated at each operation 221 to 225 in APR operation 220 to meet IR requirements of the integrated circuit with a better PPA (performance, power, and area). Further details thereof will be described.

At floorplanning operation 221, the APR tool identifies circuit elements and/or standard cells, which are to be electrically connected to each other and which are to be placed in close proximity to each other, for reducing the area of the IC and/or reducing time delays of signals travelling over the interconnections or nets connecting the electrically connected circuit elements. In some embodiments, the APR tool performs partitioning to divide the design of the IC into a plurality of blocks or groups, such as clock and logic groups.

At PDN planning operation 241, the APR tool or the machine-learning model 1045 performs power planning based on the partitioning and/or the floorplan of a semiconductor substrate of the IC design, to generate an initial power delivery network (e.g., a power grid structure) which includes several conductive layers, such as metal layers. The initial power delivery network, which is in either a sparse type or a dense type, can be disposed on the frontside, backside, or dual sides (i.e., including both the frontside and backside) of the semiconductor substrate, depending on the preset type of machine-learning model 1045 being used.

At cell placement operation 222, the APR tool performs cell placement. For example, standard cells configured to provide pre-defined functions and having pre-designed layout diagrams are stored in cell library 1044. The APR tool accesses various standard cells from cell library 1044, and places these standard cells in an abutting manner to generate an IC layout diagram corresponding to the IC schematic.

In some embodiments, the IC layout diagram (e.g., first IC layout diagram) generated by cell placement operation 222 includes the power grid structure and a plurality of standard cells (or “cells” in short), each standard cell including one or more circuit elements and/or one or more nets. A circuit element can be an active element or a passive element. Examples of active elements include, but are not limited to, transistors and diodes. Examples of transistors include, but are not limited to, metal oxide semiconductor field effect transistors (MOSFET), complementary metal oxide semiconductor (CMOS) transistors, bipolar junction transistors (BJT), high voltage transistors, high frequency transistors, p-channel and/or n-channel field effect transistors (PFETs/NFETs), etc.), FinFETs, planar MOS transistors with raised source/drains, or the like. Examples of passive elements include, but are not limited to, capacitors, inductors, fuses, and resistors. Examples of nets include, but are not limited to, vias, conductive pads, conductive traces, and conductive redistribution layers, or the like. In some embodiments, each standard cell may be a macro including one or more logic gates. Examples of a macro including one logic gate can be an NAND, NOR, XOR, XOR gate, etc. Examples of a macro including plural logic gates or a CMOS complex gate can be a 2-bit full adder, a D flip-flop, a latch, a buffer, and- or-invert gate (AOI), or-and-inverter gate (OAI), etc.

The IC layout diagram generated by cell placement operation 222 is refined by PDN refinement operation 242. For example, at PDN refinement operation 242, the processor 102 may execute the machine-learning model 1045 to perform an inference process (e.g., first inference process) using the IC layout diagram generated by cell placement operation 222, thereby alternating the distribution of the conductive layers and positions of standard cells within each grid of the power density network to generate a refined IC layout diagram (e.g., refined first IC layout diagram) with a better PPA, depending on the features of standard cells within each grid of the layout diagram. For example, the features of the standard cells within each grid of the layout diagram may include, but are not limited to, power density, cell driving, cell functionality, toggle rates, routing congestion, pin density, timing critical paths, etc., but the disclosure is not limited thereto. The refined IC layout diagram generated by PDN refinement operation 242 is sent to the APR tool for clock tree synthesis (CTS).

At clock tree synthesis operation 223, the APR tool performs clock tree synthesis to minimize clock skews and/or delays potentially present due to the placement of standard cells in the IC layout diagram generated by PDN refinement operation 242. The clock tree synthesis may include an optimization process to ensure that signals are transmitted and/or arrived at appropriate timing. For example, during the optimization process within the clock trec synthesis, the APR tool may insert one or more vias into the IC layout diagram to add and/or remove slack (timing for signal arrival) and/or insert one or more clock buffers into the IC layout diagram to achieve desired clock timing. Accordingly, another IC layout diagram (e.g., second IC layout diagram) is generated by clock tree synthesis operation 223.

The IC layout diagram generated by clock tree synthesis operation 223 is refined by PDN refinement operation 243. For example, at PDN refinement operation 243, the processor 102 may execute the machine-learning model 1045 to perform another inference process (e.g., second inference process) using the IC layout diagram generated by clock tree synthesis operation 223, thereby alternating the distribution of the conductive layers and positions of standard cells within each grid of the power density network to generate a refined IC layout diagram (e.g., refined second IC layout diagram) with a better PPA, depending on the features of standard cells within each grid of the layout diagram. The refined IC layout diagram generated by PDN refinement operation 243 is sent to the APR tool for routing.

At routing operation 224, the APR tool performs routing to route various nets (e.g., conductive wires) interconnecting the placed standard cells. The routing is performed to ensure that the routed interconnections or nets satisfy a set of constraints. For example, routing operation 224 includes global routing, track assignment and detailed routing. During the global routing, routing resources used for interconnections or nets are allocated. For example, the routing area is divided into a number of sub-areas, pins of the placed standard cells are mapped to the sub-areas, and nets are constructed as sets of sub-areas in which interconnections are physically routable. During the track assignment, the APR tool assigns interconnections or nets to corresponding conductive layers of the IC layout diagram. During the detailed routing, the APR tool routes interconnections or nets in the assigned conductive layers and within the global routing resources. For example, detailed physical interconnections are generated within the corresponding sets of sub-areas defined at the global routing and in the conductive layers defined at the track assignment. After routing operation 224, the APR tool outputs the IC layout diagram (e.g., third IC layout diagram) including the power grid structure, placed standard cells and routed nets. The described APR tool is an example. Other arrangements are within the scope of various embodiments. For example, in one or more embodiments, one or more of the described operations are omitted.

The IC layout diagram generated by routing operation 224 is further refined by PDN refinement operation 244. For example, at PDN refinement operation 244, the processor 102 may execute the machine-learning model 1045 to perform yet another inference process (e.g., third inference process) using the IC layout diagram generated by routing operation 224, thereby alternating the distribution of the conductive layers and positions of standard cells within each grid of the power density network to generate a refined IC layout diagram (e.g., refined third IC layout diagram) with a better PPA, depending on the features of standard cells within each grid of the layout diagram. The refined IC layout diagram generated by PDN refinement operation 244 is sent to the APR tool for post-routing optimization.

In some embodiments, post-routing optimization operation 225 can be regarded as a sign-off operation. At post-routing optimization operation 225, one or more physical and/or timing verifications are performed. For example, post-routing optimization operation 225 includes one or more of a resistance and capacitance (RC) extraction, a layout-versus-schematic (LVS) check, a design rule check (DRC) and a timing sign-off check (also referred to as a post-layout simulation). Other verification processes are usable in other embodiments.

In some embodiments, an EDA tool performs an RC extraction to determine parasitic parameters, e.g., parasitic resistance and parasitic capacitance, of components in the IC layout diagram for timing simulations in a subsequent operation.

In some embodiments, an LVS checking tool (e.g., one of the EDA tools) may perform an LVS check to ensure that the generated IC layout diagram corresponds to the design of the IC. Specifically, the LVS checking tool identifies electrical components and connections from the patterns of the generated IC layout diagram, and then generates a layout netlist representing the identified electrical components and connections. The LVS checking tool compares the layout netlist generated from the IC layout diagram with the schematic netlist of the IC design. If the two netlists match within a certain tolerance, the LVS check is passed. Otherwise, corrections are made to the IC layout diagram and/or the design of the IC, and the process is returned to IC design operation 210 and/or APR operation 220.

In some embodiments, a DRC tool (e.g., one of the EDA tools) may perform a DRC to ensure that the IC layout diagram satisfies certain manufacturing design rules to ensure manufacturability of the IC. If any design rules are violated, corrections are made to the IC layout diagram and/or the design of the IC, and the process is returned to IC design operation 210 and/or APR operation 220. Examples of design rules include, but are not limited to, a width rule specifying a minimum width of a pattern, a spacing rule specifying a minimum spacing between adjacent patterns, an area rule specifying a minimum area of a pattern in the IC layout diagram, etc. In some embodiments, at least one of the design rules is voltage-dependent. A DRC that is performed to check compliance of an IC layout diagram with one or more voltage-dependent design rules is referred to as a VDRC.

In some embodiments, the EDA tool performs a timing sign-off check (post-layout simulation), using extracted parasitic parameters, to determine whether the IC layout diagram meets a predetermined specification of one or more timing requirements. If the simulation shows that the IC layout diagram does not meet the predetermined specification, e.g., the parasitic parameters cause undesirable delays, corrections are made to at least one of the IC layout diagram or the IC design by returning the process to IC design operation 210 and/or APR operation 220. Otherwise, the IC layout diagram is refined by PDN refinement operation 245.

At PDN refinement operation 245, the processor 102 may execute the machine-learning model 1045 to perform yet another inference process (e.g., fourth inference process) using the IC layout diagram generated by post-routing optimization operation 225, thereby alternating the distribution of the conductive layers and positions of standard cells within each grid of the power density network to generate a refined IC layout diagram (e.g., refined fourth IC layout diagram) with improved PPA, depending on the features of standard cells within each grid of the layout diagram. The refined IC layout diagram can then be passed to manufacturing or additional verification processes.

In some other approaches, a power analysis is performed after routing operation 224, e.g., during post-routing optimization operation 225. If the power analysis results do not meet the design specifications, the power delivery network delivering power to the standard cells in the IC layout diagram is to be redesigned or modified. This, in turn, leads to changes in cell placement and/or routing, potentially causing a long turnaround times. The drawbacks can be avoided in some embodiments described herein.

In some embodiments, operations 241 to 245 within the power delivery network refinement stage 240 can refine the IC layout diagram generated at each stage of APR process 220 on a grid basis, allowing the refined IC layout diagram generated at each stage to meet the IR (current-resistance) requirement (e.g., including issues of power-hungry cells, IR hotspot, etc.) with a better PPA. For example, PDN refinement operation 242 can adaptively refine the IC layout diagram generated at cell placement operation 222, and the refined IC layout diagram can include an adaptive PDN with a dense PDN for grids with high-density power-hungry cells and a sparse PDN for grids with low-density cells. Additionally, PDN refinement operation 243 can adaptively refine the IC layout diagram generated at clock tree synthesis operation 223, and the refined IC layout diagram can include another adaptive PDN to address the IR hotspots induced by newly clock buffers added by clock tree synthesis operation 223.

### Training Procedure of Machine-Learning Model

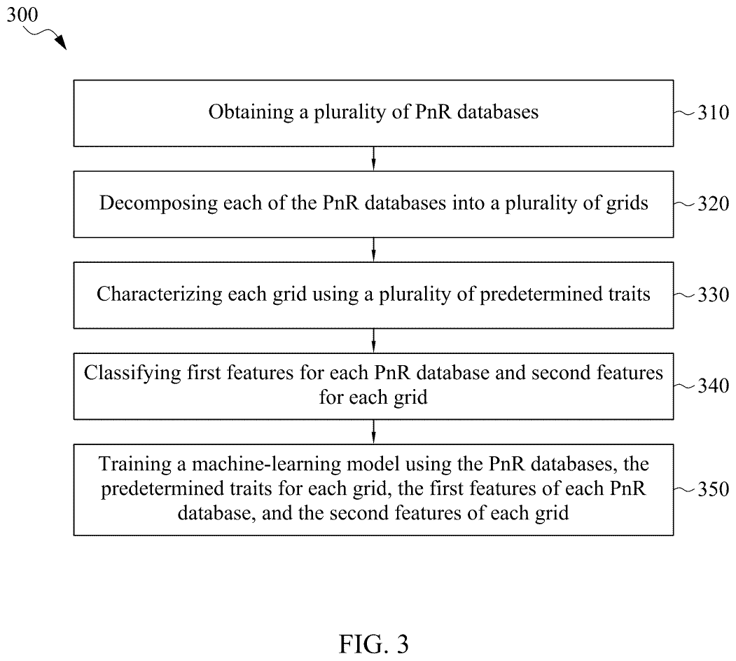

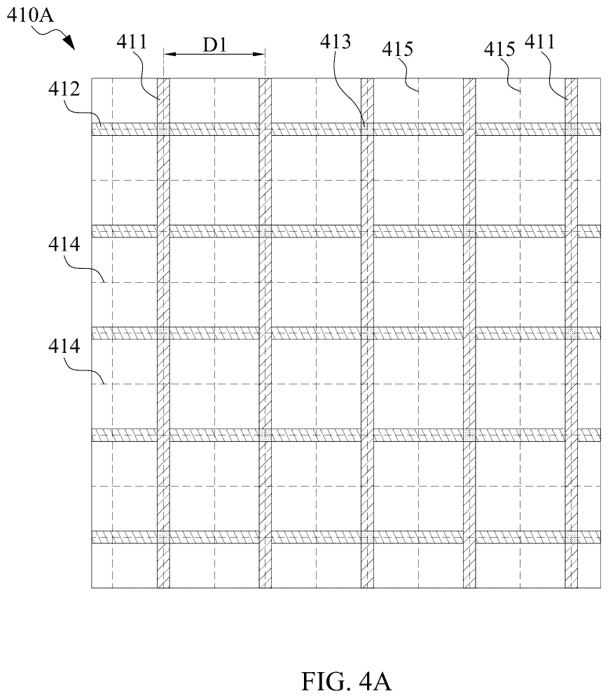

FIG. 3 is a flowchart of the training procedure of the machine-learning model to generate an adaptive power delivery network in an integrated circuit in accordance with some embodiments of the present disclosure. The method of FIG. 3 may include other operations not illustrated here, and the various illustrated operations of method may be performed in a different order than shown. The method of FIG. 3 may be performed by one or more processing devices within a computing device.

In some embodiments, flow 300 shown in FIG. 3 illustrates the training procedure of the machine-learning model 1045 for use in APR operation 220 shown in FIG. 2. In operation 310, a plurality of PnR (place and route) databases are obtained. For example, the PnR databases may include a plurality of IC layout diagrams of one or more IC designs, along with PDN factors and design factors. The PDN factors may include PDN types, PDN structures, and PDN density.

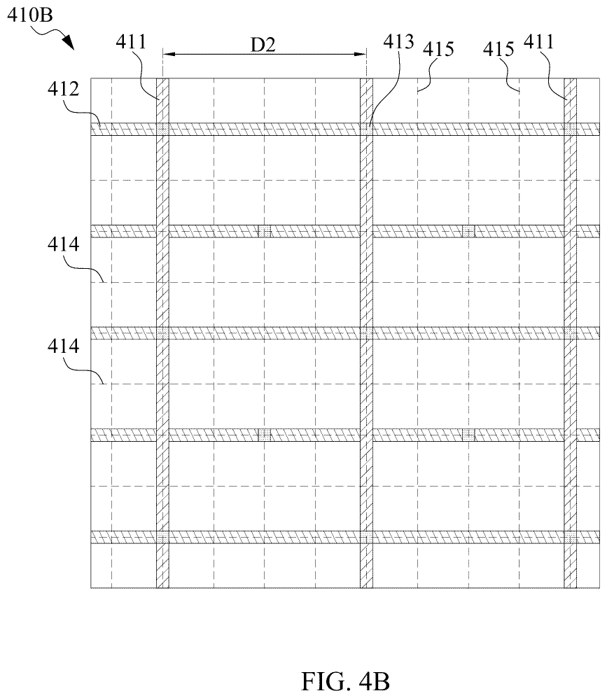

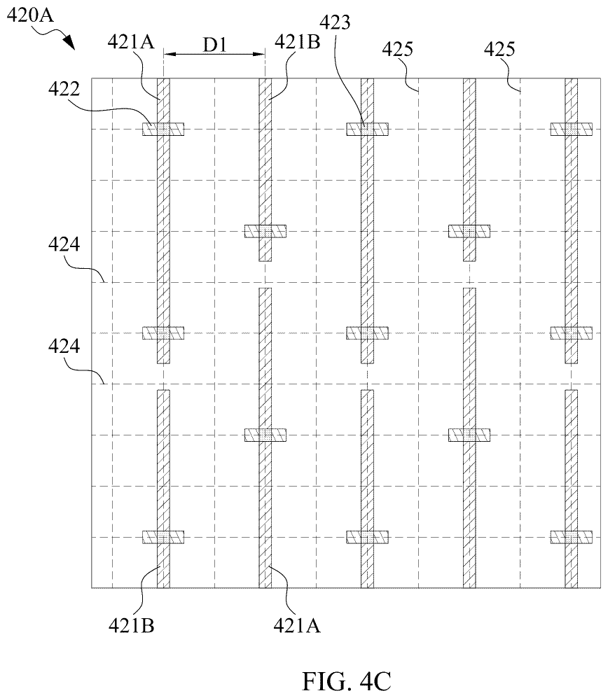

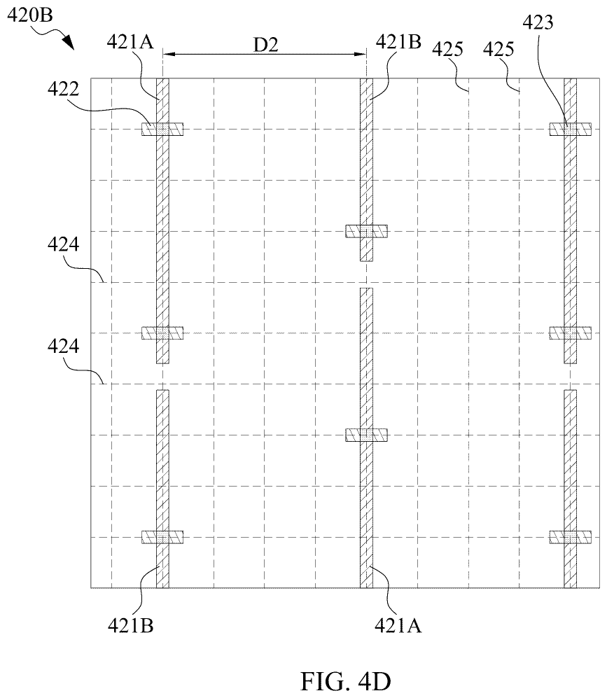

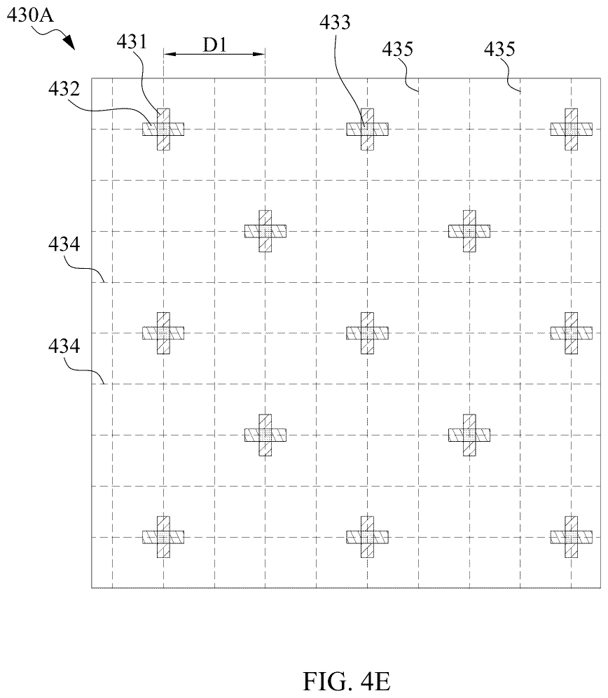

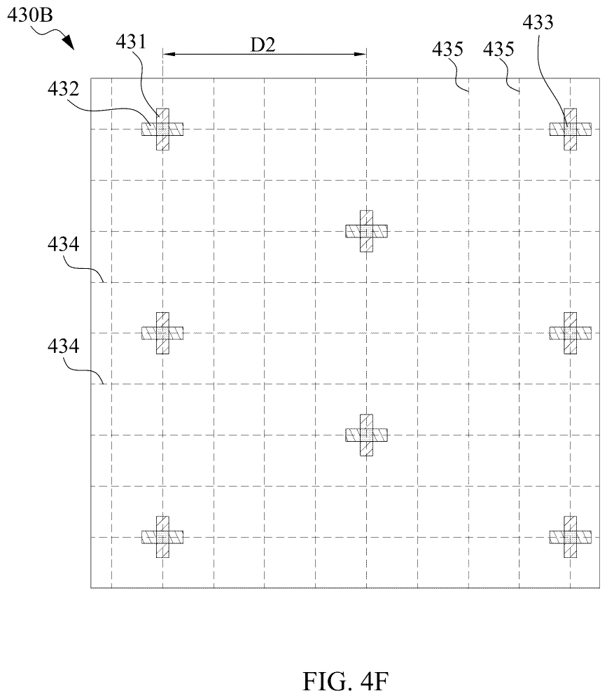

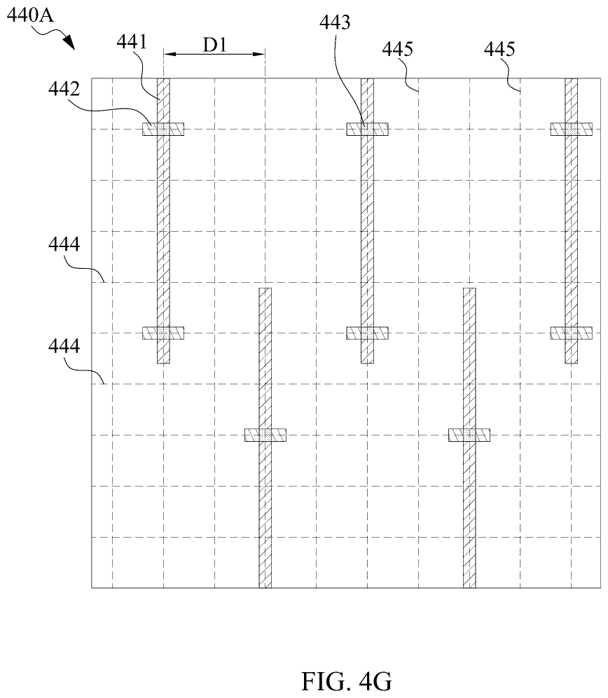

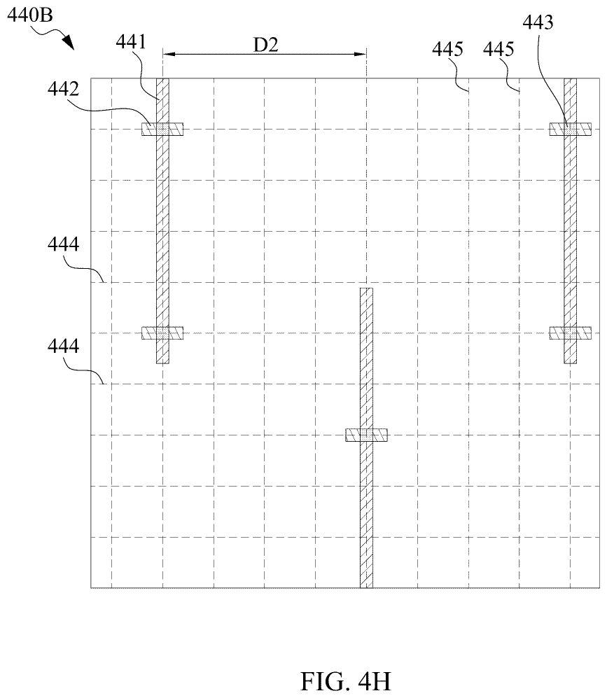

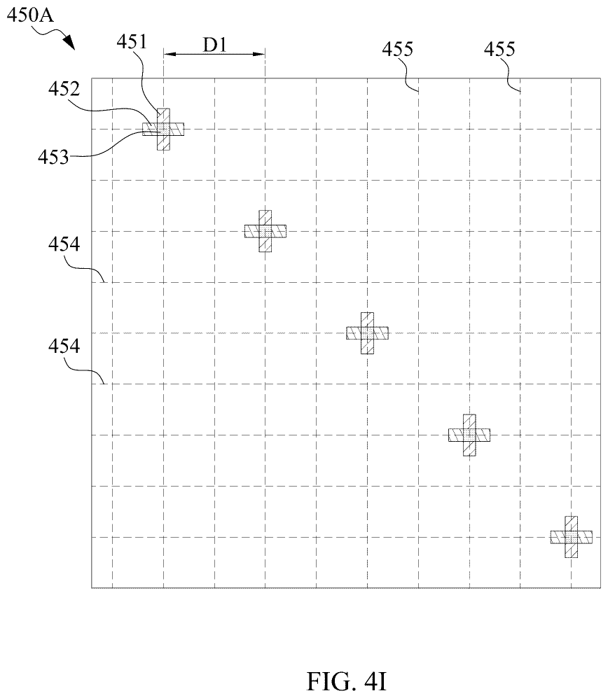

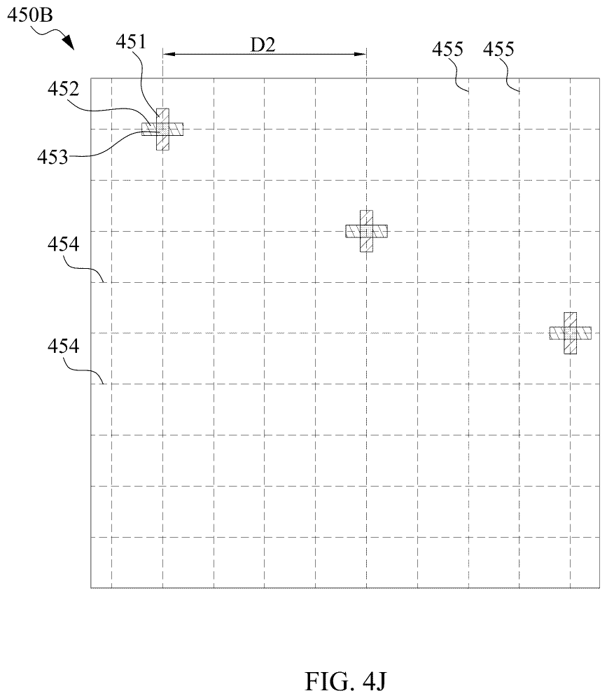

In some embodiments, the PDN type may refer to whether the PDN is located at the frontside, backside, or dual-side of the semiconductor substrate within each PnR database. The PDN structures may refer to the arrangement of the PDN and routing, such as strap (or stripe), long/short pillar, long/short staggered pillar, long/short aligned pillar, etc., as illustrated in FIGS. 4A to 4J, respectively. The PDN density may include a dense or sparse PDN. When the PDN is a dense PDN, it indicates that a relatively larger number of conductive wires are within a unit area. On the other hand, when the PDN is a sparse PDN, it indicates that a relatively smaller number of conductive wires are within a unit area. Additionally, a predetermined density threshold can be set to distinguish the dense PDN from the sparse PDN.

In some embodiments, the design factors may include operating frequencies, design styles, routing congestion, pin density and utilization. For example, the operating frequencies may refer to the frequency at which the functional circuitry (e.g., standard cells) formed on the semiconductor substrate is operating, such as 100 MHz, 5 GHZ, etc. The design styles may refer to the functionality of the IC layout diagram, such as central processing unit (CPU), graphics processing unit (GPU), neural processing unit (NPU), data processing unit (DPU), system-on-chip (SoC), etc. The cell driving may refer to the cell driving capability of the standard cells within the IC layout diagram. The routing congestion may refer to the level of routing congestion of the IC layout diagram, such as high, medium, or low. The pin density and utilization may be dependent. For example, a high pin density indicates a high utilization, while a low pin density indicates a low utilization. In some embodiments, the pin density and utilization of each IC layout diagram can be considered collectively as one design factor. Alternatively, the pin density and utilization of each IC layout diagram can be considered as separate design factors.

In operation 320, each of the PnR databases are decomposed into a plurality of grids. For example, the grids may be of the same size, and they may be fixed during APR operation 220 shown in FIG. 2.

In operation 330, each grid is characterized using a respective combination of different traits. For example, the traits may include, but is not limited to, power density, cell driving, cell functionality, toggle rate, routing congestion, pin density, and timing critical path. For example, most of the traits, power density, cell driving, toggle rate, congestion, pin density, and critical path can be classified into three levels. For example, each of the power density, toggle rate, congestion, pin density, and critical path can be classified into three levels, such as high, medium, and low. Additionally, the cell driving can also be classified into three levels, such as strong, medium, and weak. Since each grid may include one or more standard cells, the cell functionality may refer to the type of logic gates within each grid, such as an inverter, NAND, NOR, D flip-flop, etc.

In operation 340, first features of each PnR database and second features of each grid are classified. For example, the first features may refer to the performance, power, and area, which is collectively referred to as PPA, for each PnR database. The second features may refer to the cell (e.g., type of logic gates), wire delays, and wire length in each grid.

In operation 350, the machine-learning model 1045 is trained using the PnR databases, the predetermined traits for each grid, the first features of each PnR database, and the second features of each grid. For example, after the training procedure is complete, the trained machine-learning model 1045 can be used in APR operation 220 shown in FIG. 2 to adaptively adjust the PDN within the IC layout diagram on a grid basis. In some embodiments, the machine-learning model 1045 may be a K-nearest neighbors (KNN) model or any other classification machine-learning models, but the present disclosure is not limited thereto.

FIGS. 4A to 4J are diagrams of different PDN structures in accordance with some embodiments of the present disclosure.

In some embodiments, referring to FIG. 4A, the PDN structure within grid 410A can be referred to as a “stripe” or “strap” structure. For example, grid 410A may include first tracks 414 extending along a first direction (e.g., horizontal direction), and second tracks 415 extending along a second direction (e.g., vertical direction) different from the first direction. Additionally, the first tracks 414 are parallel and evenly distributed along the second direction, while the second tracks 415 are parallel and evenly distributed along the first direction. The PDN within grid 410A is formed by a plurality of stripes 411, each stripe 411 extending from a first edge (e.g., upper edge) to a second edge (e.g., bottom edge) of grid 410A, wherein the first edge is opposite to the second edge. The routing network within grid 410A is formed by a plurality of stripes 412, each stripe 412 extending from a third edge (e.g., left edge) of grid 410A to a fourth edge (e.g., right edge) opposite to the third edge, wherein the third edge is opposite to the fourth edge. Additionally, one or more vias 413 may be formed at intersections between the PDN and routing network.

In some embodiments, grid 410B shown in FIG. 4B may be similar to grid 410A shown in FIG. 4A, with the difference being that the distance D2 between two adjacent stripes 411 in FIG. 4B is greater than distance D1 between two adjacent stripes 411 in FIG. 4A. Specifically, the PDN structures within grids 410A and 410B can be referred to as a dense stripe structure and a sparse stripe structure, respectively.

In some embodiments, referring to FIG. 4C, the PDN structure within grid 420A can be referred as a “long-pillar” structure. Tracks 424 and 425 shown in FIG. 4C may be similar to tracks 414 and 415 shown in FIG. 4A. The PDN within grid 420A is formed by a plurality of pairs of pillars 421A and 421B, with each pair on a respective track 425. Each pillar 421A is slightly greater than each pillar 421B. Additionally, the routing network within grid 420A is formed by a plurality of short pillars 422, each short pillar 422 having a length smaller than or equal to the interval between two adjacent tracks 425. Pillars 421A and 421B may be arranged in an interleaved fashion, and are placed across several intervals between two adjacent first tracks 424. Additionally, one or more vias 423 may be formed at intersections between the PDN and routing network. Since long pillars 421A and 421B are placed and aligned on the same track 425, the PDN within grid 420A can also be regarded as a “long aligned pillar” structure.

In some embodiments, grid 420B shown in FIG. 4D may be similar to grid 420A shown in FIG. 4C, with the difference being that the distance D2 between two adjacent stripes 421 in FIG. 4D is greater than distance D1 between two adjacent stripes 421 shown in FIG. 4C. Specifically, the PDN structures within grids 420A and 420B can be referred to as a dense long pillar structure and a sparse long pillar structure, respectively.

In some embodiments, referring to FIG. 4E, the PDN structure within grid 430A can be referred as a “short-pillar” structure. Tracks 434 and 435 shown in FIG. 4E may be similar to tracks 414 and 415 shown in FIG. 4A. The PDN within grid 430A is formed by a plurality of pillars 431 arranged in an interleaved fashion, with each pillar 431 having a length smaller than or equal to the interval between two adjacent tracks 434. For example, three pillars 431 are arranged on the same track 435, while two pillars 431 are arranged on another track 435. Additionally, the routing network within grid 430A is formed by a plurality of short pillars 432, each short pillar 432 having a length smaller than or equal to the interval between two adjacent tracks 435. Since short pillars 431 are placed and aligned on the same track 435, the PDN within grid 430A can also be regarded as a “short aligned pillar” structure.

In some embodiments, grid 430B shown in FIG. 4F may be similar to grid 430A shown in FIG. 4E, with the difference being that the distance D2 between two adjacent pillars 431 in FIG. 4F is greater than distance D1 between two adjacent pillars 431 shown in FIG. 4E. Specifically, the PDN structures within grids 430A and 430B can be referred to as a dense short pillar structure and a sparse short pillar structure, respectively.

In some embodiments, referring to FIG. 4G, the PDN structure within grid 440A can be referred as a “long staggered pillar” structure. Tracks 444 and 445 shown in FIG. 4G may be similar to tracks 414 and 415 shown in FIG. 4A. The PDN within grid 440A is formed by a plurality of pillars 441 arranged in an interleaved fashion, with each pillar 441 being placed across several intervals between two adjacent tracks 444. For example, the leftmost pillar 441 is disposed on an upper side of its respective track 445, while the next pillar 441 is disposed on the bottom side of its respective track 445. In other words, the long pillars 441 are placed in a staggered fashion on different tracks 445. Additionally, the routing network within grid 440A is formed by a plurality of short pillars 442, each short pillar 442 having a length smaller than or equal to the interval between two adjacent tracks 445.

In some embodiments, grid 440B shown in FIG. 4H may be similar to grid 440A shown in FIG. 4G, with the difference being that the distance D2 between two adjacent pillars 441 in FIG. 4H is greater than distance D1 between two adjacent pillars 441 shown in FIG. 4G. Specifically, the PDN structures within grids 440A and 440B can be referred to as a dense long staggered pillar structure and a sparse long staggered pillar structure, respectively.

In some embodiments, referring to FIG. 4I, the PDN structure within grid 450A can be referred as a “short staggered pillar” structure. Tracks 454 and 455 shown in FIG. 4I may be similar to tracks 414 and 415 shown in FIG. 4A. The PDN within grid 450A is formed by a plurality of pillars 451 arranged in a staggered fashion, with each pillar 451 having a length smaller than or equal to the intervals between two adjacent tracks 454. For example, the pillars 441 are disposed on different tracks 455. Additionally, the routing network within grid 450A is formed by a plurality of short pillars 452, each short pillar 452 having a length smaller than or equal to the interval between two adjacent tracks 445.

In some embodiments, grid 450B shown in FIG. 4J may be similar to grid 450A shown in FIG. 4I, with the difference being that the distance D2 between two adjacent pillars 451 in FIG. 4J is greater than distance D1 between two adjacent pillars 451 shown in FIG. 4I. Specifically, the PDN structures within grids 450A and 450B can be referred to as a dense short pillar structure and a sparse short pillar structure, respectively.

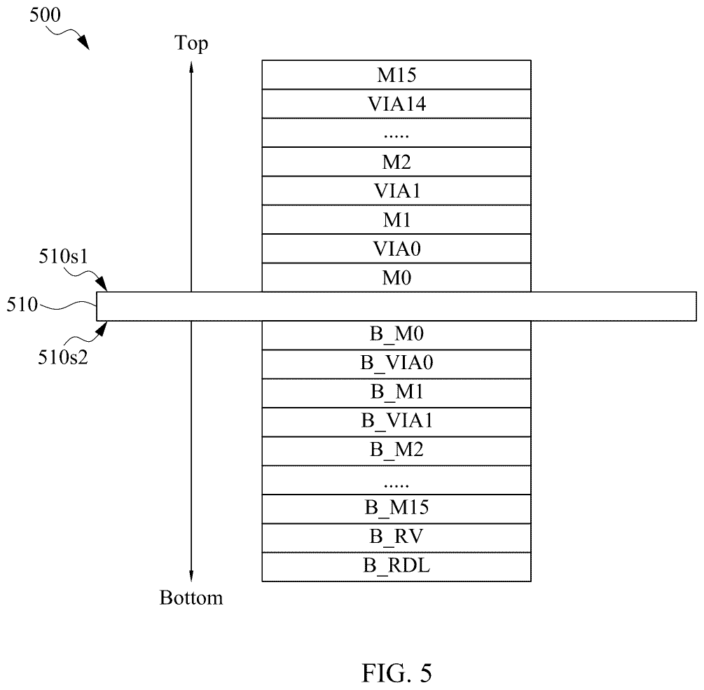

FIG. 5 is a diagram illustrating different layers on the frontside and backside of a semiconductor substrate in accordance with some embodiments of the present disclosure.

In some embodiments, the semiconductor substrate 510 may have a frontside 510s1 and a backside 510s2. The IC layout diagram generated at operations 223 to 225 may include a plurality of frontside layers and/or a plurality of backside layers, The frontside layers may include M0 (metal layer 0), VIA0 (via layer 0), M1 (metal layer 1), VIA1 (via layer 1), M2 (metal layer 2), etc., that are formed on the frontside 510s1 of the semiconductor substrate 510. For purposes of description, M15 (metal layer 15) is the topmost metal layer (e.g., Mtop). Similarly, the backside layers may include B_M0 (backside metal layer 0), B_VIA0 (backside via layer 0), B_M1 (backside metal layer 1), B_RV (backside redistribution vias), B_RDL (backside redistribution layer), etc., that are formed on the backside 510s2 of the semiconductor substrate 510. For purposes of description, B_M15 is the bottommost backside metal layer or topmost backside metal layer.

In some embodiments, the standard cells may be disposed between layers M0 to M2 on the frontside 510s1 of the semiconductor substrate 510 within the IC layout diagram. When a frontside PDN is employed on the frontside 510s1 of the semiconductor substrate 510 within the IC layout diagram, conductive wires of the frontside PDN may be distributed within layers M0 to M15 (Mtop). When a backside PDN is employed on the backside 510s2 of the semiconductor substrate 510 within the IC layout diagram, conductive wires of the backside PDN may be distributed within backside layers B_M0 to B_M15 (BMtop). Additionally, when a dual-side PDN is employed within the IC layout diagram, it indicates that both the frontside PDN and backside PDN are employed. As a result, conductive wires of the dual-side PDN can be distributed within layers M0 to M15 and B_M0 to B_M15.

More specifically, the pillars of the PDN and those of the routing network within the PDN structures shown in FIGS. 4A to 4E are not necessarily within the same metal layer. The PDN and routing network can be electrically connected through one or more vias formed at the intersections therebetween, depending on the arrangement of the EDA tool.

### Inference Procedure of Machine-Learning Model

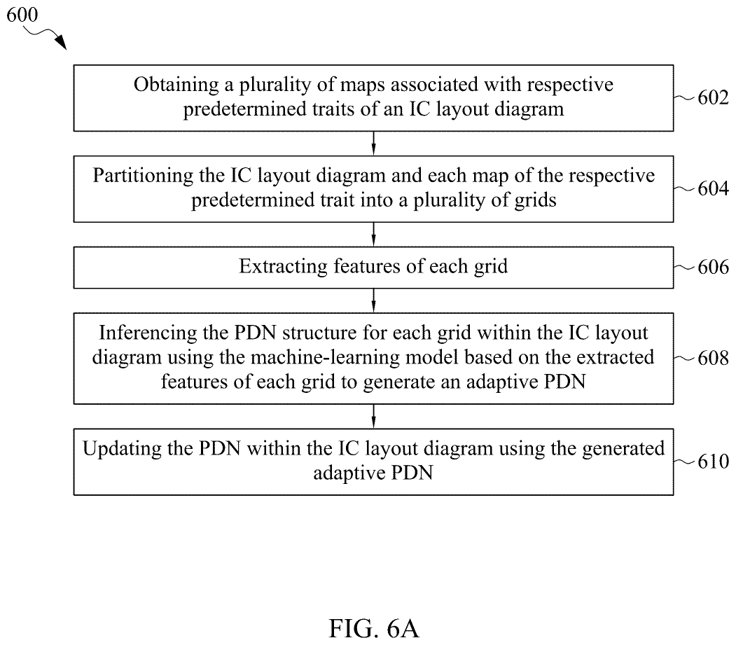

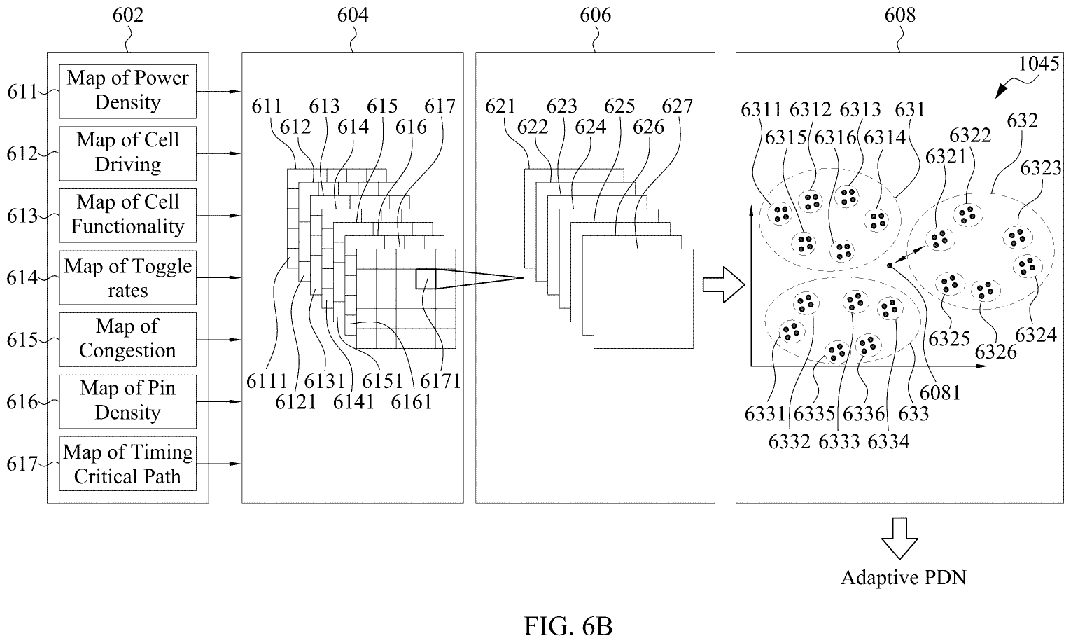

FIG. 6A is a flowchart of the inference procedure of a machine-learning model in accordance with some embodiments of the present disclosure. FIG. 6B is a diagram illustrating the inference procedure of the machine-learning model in FIG. 6A.

In some embodiments, flow 600 in FIG. 6A illustrates various operations within the inference procedure of the machine-learning model 1045. In operation 602, a plurality of maps 611 to 617 associated with respective predetermined traits of an IC layout diagram are obtained. For example, the predetermined traits may include power density, cell driving, cell functionality, toggle rates, congestion, pin density, and timing critical path. Thus, the maps 611 to 617 shown in FIG. 6B can be referred to as a map of power density, map of cell driving, map of cell functionality, map of toggle rates, map of congestion, map of pin density, map of timing critical path, respectively. It should be noted that size of these maps 611 to 617 may be substantially the same as that of the IC layout diagram.

In operation 604, the IC layout diagram and each map associated with the respective predetermined trait are partitioned into a plurality of grids. For example, maps 611 to 617 may be partitioned into grids 6111, 6121, 6131, 6141, 6151, 6161, and 6171, respectively, as shown in the block of operation 604 in FIG. 6B. Additionally, each grid of the IC layout diagram may have a fixed size, and the partitioning of grids within the IC layout diagram may also keep the same during the APR operation 220 shown in FIG. 2.

In operation 606, features of each grids are extracted. For example, each grid within the maps can represent different features of each grid within the IC layout diagram. For example, grid 6171, which is enlarged in the block of operation 606, may include a plurality of features, each feature representing a level of the respective predetermined trait (e.g., including power density, cell driving capability, cell toggle rate, routing congestion, pin density, timing critical path) or actual standard cells (e.g., XOR, NAND, D flip-flop, etc.) being used by the respective predetermined trait (e.g., for cell functionality). For example, the levels of the predetermined traits, such as power density, cell driving capability, cell toggle rate, routing congestion, pin density, timing critical path, can be categorized into high, medium, or low (weak). For purposes of description, the features 621 to 627 within grid 6171 may refer to low power density, weak cell driving, NAND cells, high toggle rate, high congestion, high pin density, and low timing critical path, respectively.

In operation 608, the PDN structure for each grid within the IC layout diagram is inferenced using the machine-learning model 1045 based on the extracted features of each grid to generate an adaptive PDN. For example, the machine-learning model 1045 is trained using features of each grid within various layout diagrams within the PnR database (e.g., IC design storage 1062 in FIG. 1), and thus the inference procedure of the machine-learning model 1045 can be performed on a grid basis. Accordingly, the machine-learning model 1045 can predict the most suitable PDN structure for each grid based on the extracted features of each grid to generate an adaptive PDN for the IC layout diagram.

For example, the combination of difference features for each grid can be regarded as a vector, which can be mapped to respective coordinates on the multi-dimensional space. For brevity, a two-dimensional plane is illustrated in the block of operation 608 in FIG. 6B. The machine-learning model 1045 may be a K-nearest neighbors (KNN) model which identifies k-nearest neighbors to a given data point from the training set and assigns a label of the majority class among the neighbors to that data point. Additionally, the KNN model can evaluate input maps and segmented features to determine the distance between the input point (e.g., point 6081) and pre-trained categorized points. Therefore, the trained machine-learning model 1045 (e.g., a trained KNN model) is capable of classifying and generating a suitable PDN structure for each grid based on the extracted features.

In some embodiments, there may be three primary groups 631, 632, and 633 for different types of PDNs, such as frontside PDN, backside PDN, and dual-side PDN. Additionally, each of primary group 631 to 633 may include six sub-groups, such as sub-groups 6311 to 6316, 6321 to 6326, and 6331 to 6336, respectively. The sub-groups 6311 to 6316, 6321 to 6326, and 6331 to 6336 may refer to the dense strap, sparse strap, dense short pillar, sparse short pillar, dense long pillar, and sparse long pillar structures, as shown in FIGS. 4A, 4B, 4E, 4F, 4C, and 4D, respectively. In some embodiments, in addition to the six PDN structure described above, more sub-groups can be used in each primary group, such as the dense aligned long pillar, sparse aligned long pillar, dense aligned short pillar, and sparse aligned short pillar structures shown in FIGS. 4G to 4J. More specifically, the PDN structures can be classified by length of conductive wires (e.g., dense strap, sparse strap, dense short pillar, sparse short pillar, dense long pillar, and sparse long pillar structures), or by alignment of conductive wires (e.g., dense strap, sparse strap, dense aligned long pillar, sparse aligned long pillar, dense aligned short pillar, and sparse aligned short pillar structures).

In operation 610, the PDN within the IC layout diagram is updated using the generated adaptive PDN. For example, the inferenced (or predicted) PDN structure of each grid can form the adaptive PDN, and the PDN of each grid within the IC layout diagram can be replaced by the inferenced PDN structure of each grid. In other words, the machine-learning model 1045 is capable of adaptively updating the power delivery network within the IC layout diagram using the inferenced PDN structure of each grid.

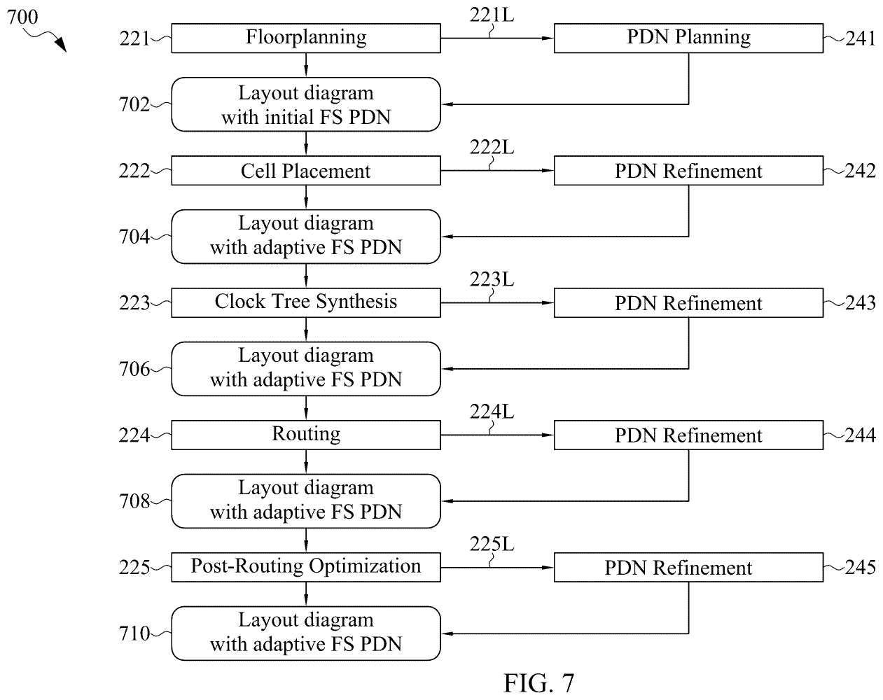

FIG. 7 is a flowchart of the procedure of constructing an adaptive frontside PDN within an IC layout diagram during various operations in an APR process in accordance with some embodiments of the present disclosure. FIGS. 8A to 8D are different perspective views of layout diagrams during different operations in flow 700 of FIG. 7.

In some embodiments, flow 700 shown in FIG. 7 may be similar to flow 200 shown in FIG. 2, with the difference being that flow 700 is particularly for constructing an adaptive frontside (FS) PDN within an IC layout diagram. For example, each of operations 222 to 225 is followed by a respective PDN refinement operation (e.g., operations 242 to 245) for the frontside PDN.

At floorplanning operation 221, the APR tool may perform floorplanning on an input IC design (e.g., an IC schematic) to generate a layout diagram 221L, such as a semiconductor substrate 810 shown in FIG. 8A. At PDN planning operation 241, the APR tool or the machine-learning model 1045 performs power planning based on the partitioning and/or the floorplan of the layout diagram 221L to generate a layout diagram 702 with an initial frontside power delivery network, which includes metal wires 801. In some embodiments, the initial power delivery network, which is in either a sparse type or a dense type, can be disposed on the frontside 810s1 of the semiconductor substrate 810, depending on the predefined settings of the APR tool. For brevity, the initial power delivery network is a sparse PDN.

At cell placement operation 222, the APR tool places one or more standard cells 820 on the frontside 810s1 of the semiconductor substrate 810 to generate a layout diagram 222L. For example, the standard cells 820 configured to provide pre-defined functions and having pre-designed layout diagrams are stored in cell library 1044. The APR tool accesses various standard cells from cell library 1044, and places these standard cells in an abutting manner to generate an IC layout diagram corresponding to the IC schematic. At PDN refinement operation 242, the processor 102 may execute the machine-learning model 1045 to perform an inference process (e.g., first inference process) using the layout diagram 222L to generate a layout diagram 704 with an adaptive frontside PDN, as shown in FIG. 8B.

At clock tree synthesis operation 223, the APR tool performs clock tree synthesis on the layout diagram 704 to generate a layout diagram 223L. For example, during the optimization process within the clock tree synthesis, the APR tool may insert one or more clock buffers 822 into the layout diagram 704 to achieve desired clock timing. At PDN refinement operation 243, the processor 102 may execute the machine-learning model 1045 to perform an inference process (e.g., a second inference process) using the layout diagram 223L to generate a layout diagram 706 with an adaptive frontside PDN, as shown in FIG. 8C. It should be noted that the locations and distribution of metal wires 801 within the frontside PDN of the layout diagram 706 are different from those within the frontside PDN of the layout diagram 704. Additionally, the number and positions of standard cells 820 in the layout diagram 706 can be different from those in the layout diagram 704.

At routing operation 224, the APR tool performs routing to route various nets (e.g., metal wires 731) interconnecting the placed standard cells 820 and clock buffers 822 within the layout diagram 706 to generate a layout diagram 224L. For example, the routing is performed to ensure that the routed interconnections or nets satisfy a set of constraints. At PDN refinement operation 244, the processor 102 may execute the machine-learning model 1045 to perform an inference process (e.g., a third inference process) using the layout diagram 224L to generate a layout diagram 708 with an adaptive frontside PDN, as shown in FIG. 8D. Routing operation 224 and PDN refinement operation 244 may alternate metal wires 801 (e.g., frontside PDN) and metal wires 831 (e.g., routing network) of the layout diagram 708, resulting in the locations and distributions of metal wires 801 and 831 within the layout diagram 708 being different from those within the layout diagram 706.

At post-routing optimization operation 225, the APR tool performs one or more physical and/or timing verifications on the layout diagram 708 to generate a layout diagram 225L. It should be noted that in order to solve the IR and timing issues of the layout diagram 225L, the APR tool may alternate the locations and distribution of standard cells 820, clock buffers 822, metal wires 801 and 831 within the layout diagram 706. As a result, the locations and distribution of standard cells 820, clock buffers 822, metal wires 801 and 831 within the layout diagram 225L can be different from those within the layout diagram 708. Similarly, the layout diagram 225L generated by post-routing optimization operation 225 is further refined by PDN refinement operation 245. At PDN refinement operation 245, the processor 102 may execute the machine-learning model 1045 to perform yet another inference process (e.g., fourth inference process) using the layout diagram 225L to generate a layout diagram 710 which may be a signed-off layout diagram to be passed to manufacturing. For brevity, the layout diagram 710, which is similar to the layout diagram 708 in FIG. 8D, is not explicitly shown.

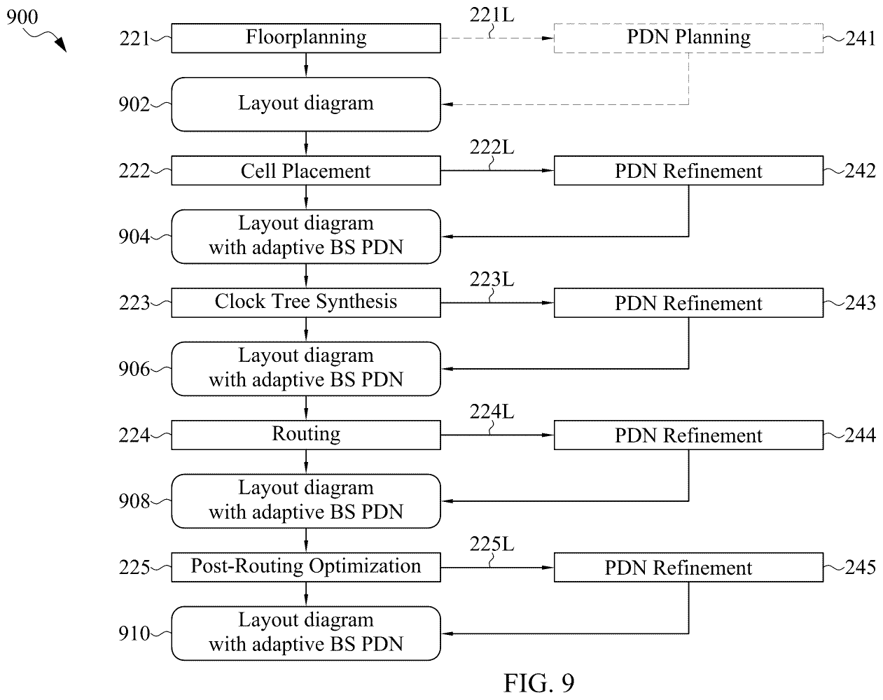

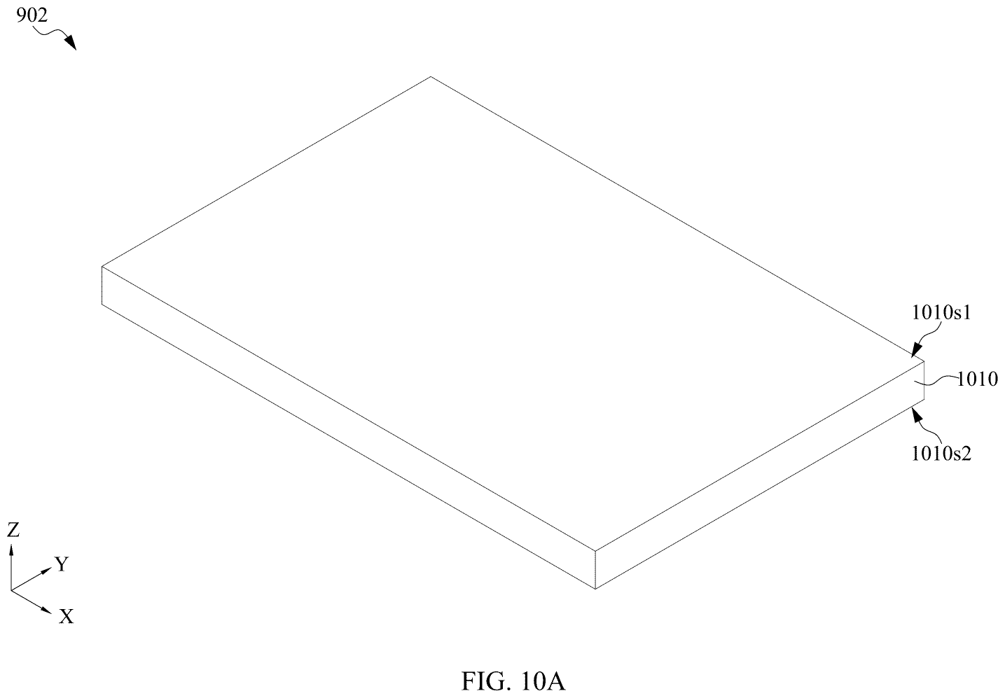

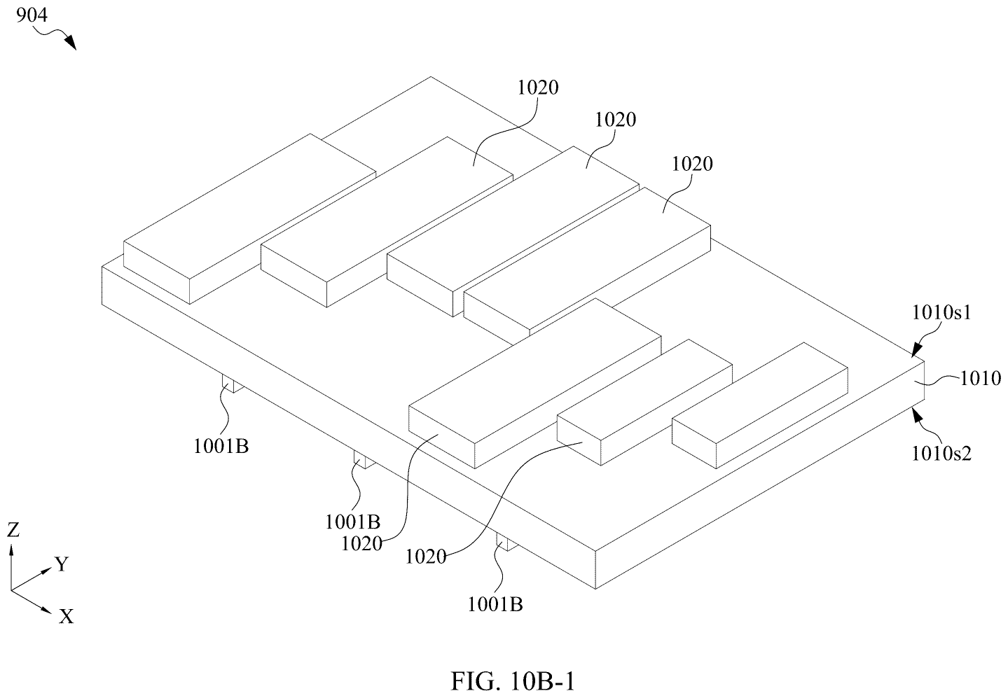

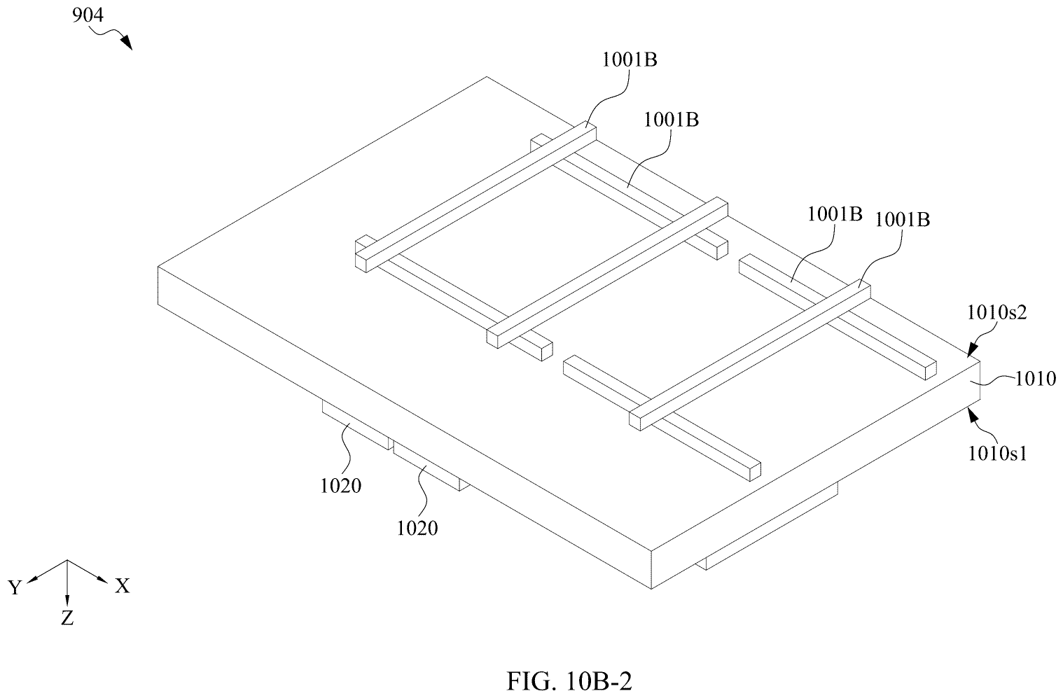

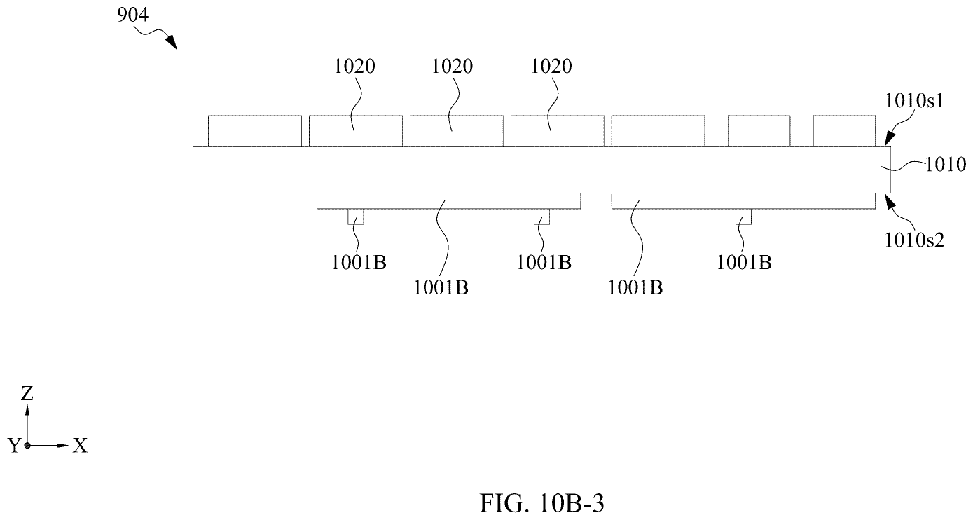

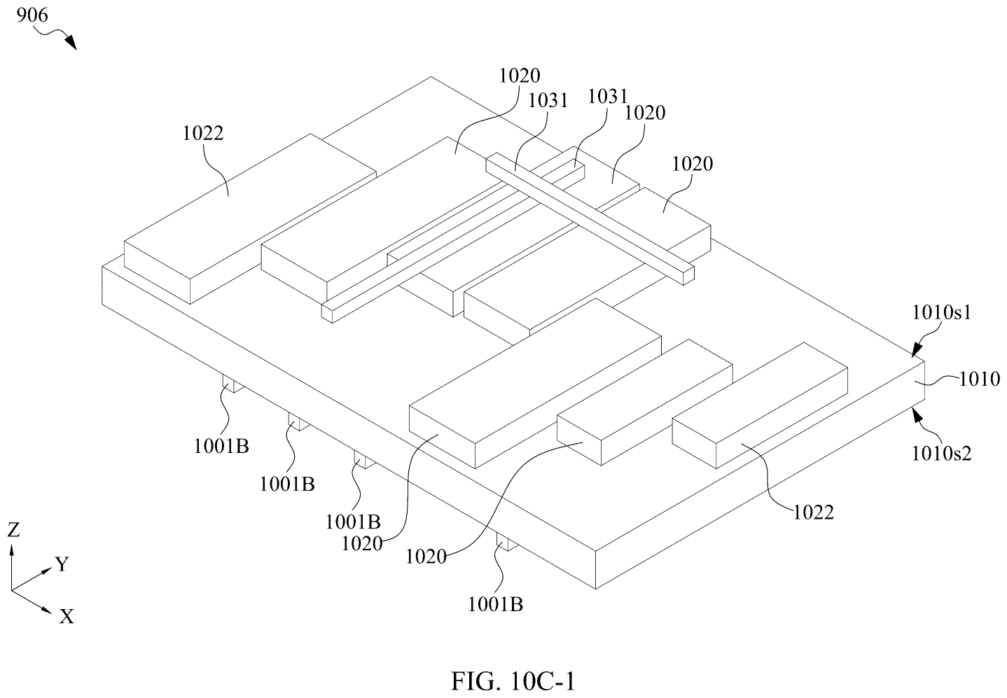

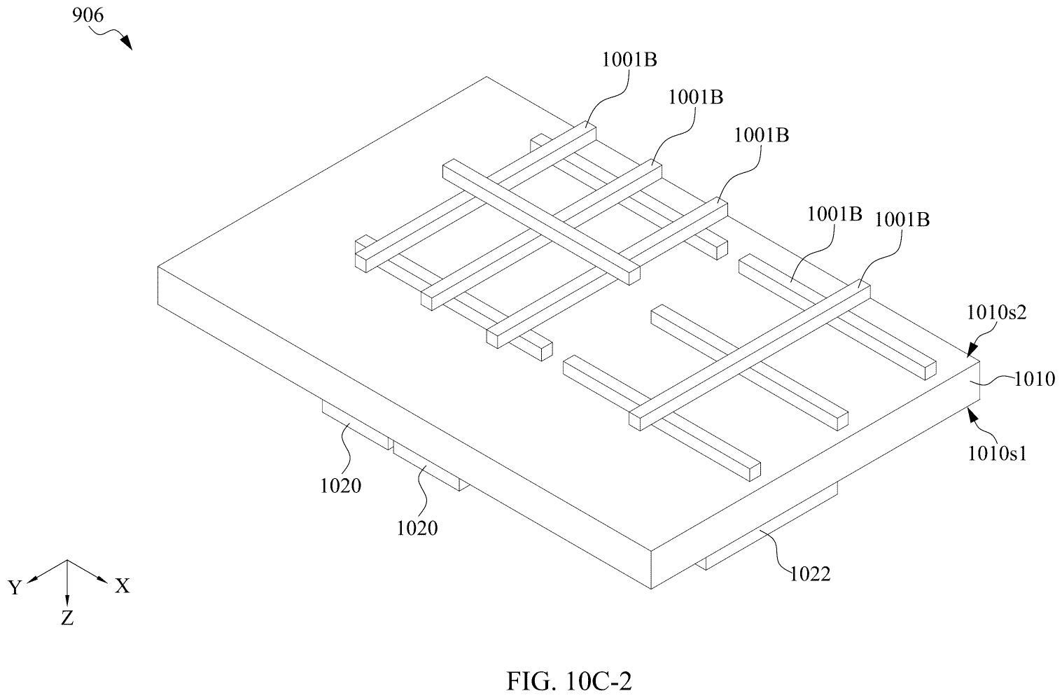

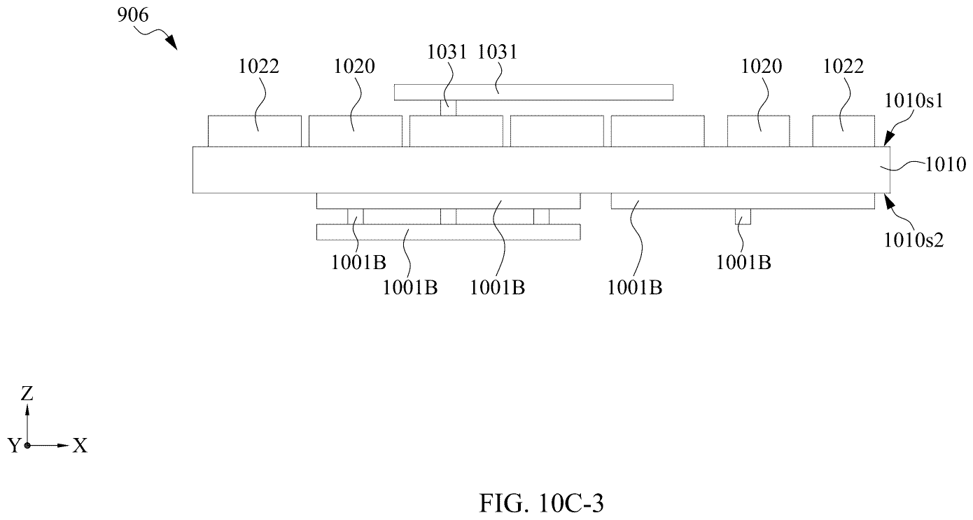

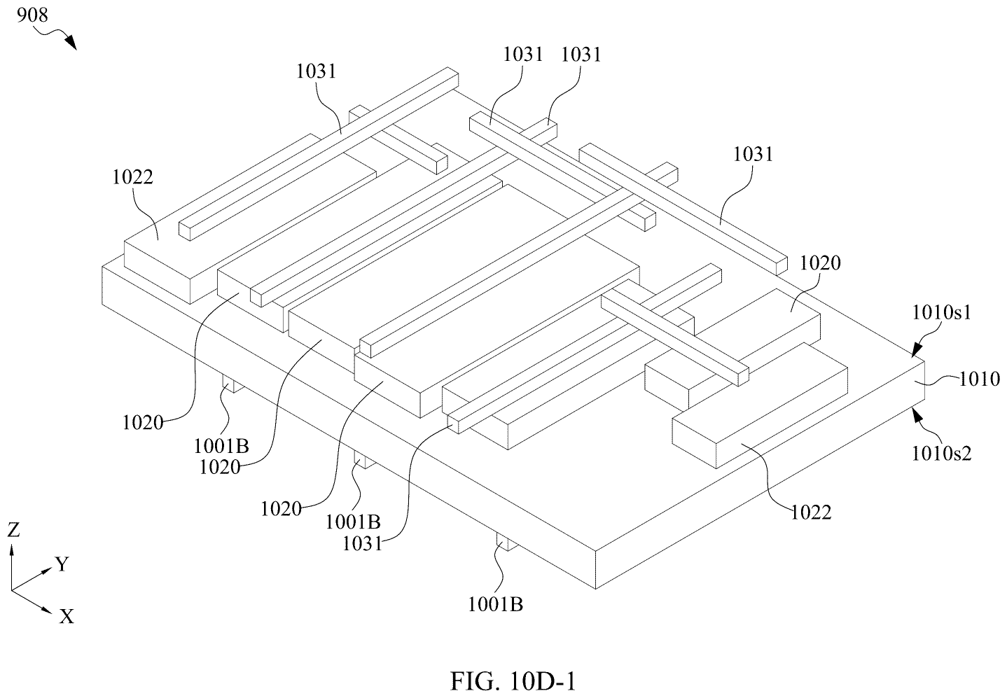

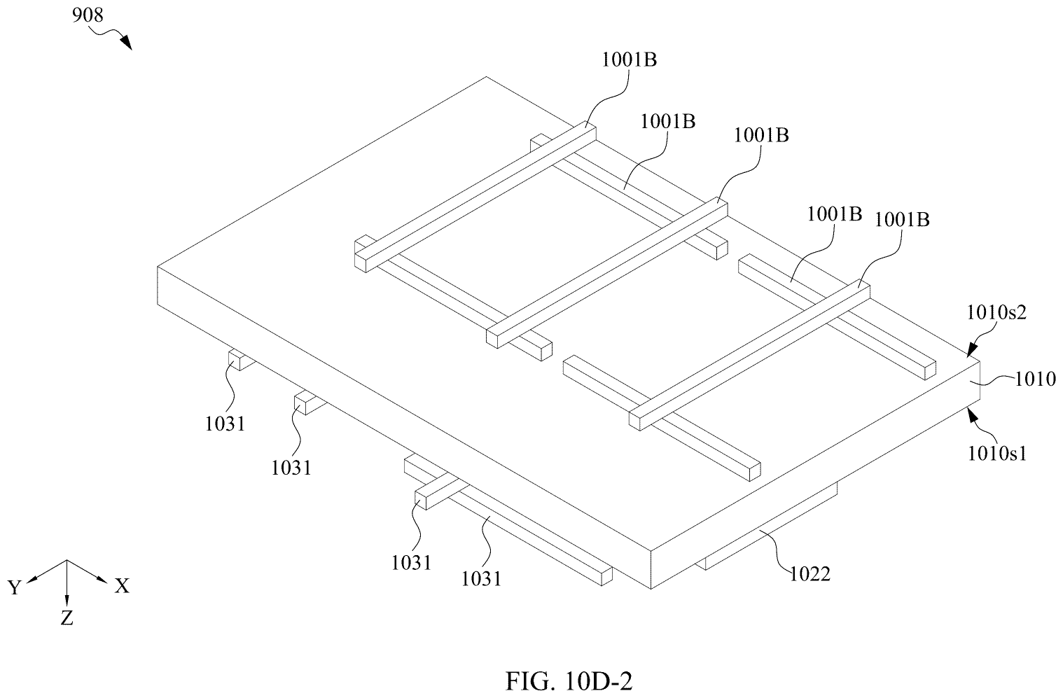

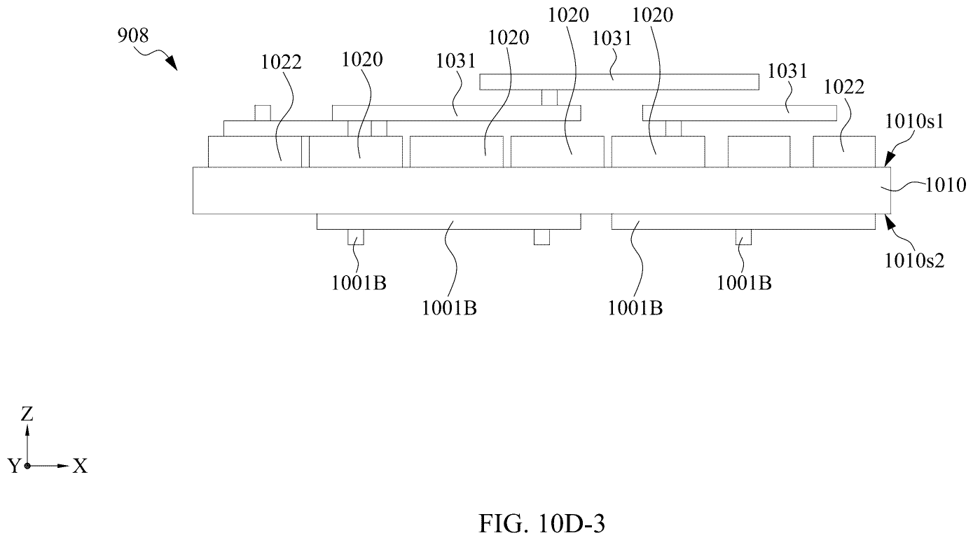

FIG. 9 is a flowchart of the procedure of constructing an adaptive backside PDN within an IC layout diagram during various operations in an APR process, in accordance with some embodiments of the present disclosure. FIGS. 10A to 10D are different perspective views of layout diagrams during different operations in flow 900 of FIG. 9.

In some embodiments, flow 900 shown in FIG. 9 may be similar to flow 200 shown in FIG. 2, with the difference being that flow 900 is particularly for constructing an adaptive backside (BS) PDN within an IC layout diagram. For example, each of operations 222 to 225 is followed by a respective PDN refinement operation (e.g., operations 242 to 245) for the backside PDN.

At floorplanning operation 221, the APR tool may perform floorplanning on an input IC design (e.g., an IC schematic) to generate a layout diagram 902, such as a semiconductor substrate 1010 shown in FIG. 10A. In some embodiments, PDN planning operation 241 is omitted, indicating that the layout diagram 902 will be used in cell placement operation 222. Alternatively, PDN planning operation 241 is performed, indicating that the APR tool or the machine-learning model 1045 performs power planning based on the partitioning and/or the floorplan of the layout diagram 221L to generate the layout diagram 902 with an initial backside power delivery network. For purposes of description, the layout diagram 902 shown in FIG. 10A is not equipped with any backside power delivery network.

At cell placement operation 222, the APR tool places one or more standard cells 1020 on the frontside 1010s1 of the semiconductor substrate 1010 to generate a layout diagram 222L. At PDN refinement operation 242, the processor 102 may execute the machine-learning model 1045 to perform an inference process (e.g., first inference process) using the layout diagram 222L to generate a layout diagram 904 with an adaptive backside PDN, as shown in FIGS. 10B-1 to 10B-3. For example, referring to FIG. 10B-1, which is a top perspective view of the layout diagram 904, the standard cells 1020 are disposed on the frontside 1010s1 of the semiconductor substrate 1010. Referring to FIG. 10B-2, which is a bottom perspective view of the layout diagram 904, the metal wires 1001B of the backside PDN are disposed on the backside 1010s2 of the semiconductor substrate 1010. Referring to FIG. 10B-3, which is a side view of the layout diagram 904, it can be seen that the standard cells 1020 and metal wires 1010B of the backside PDN are disposed on opposite sides (i.e., frontside 1010s1 and backside 1010s2) of the semiconductor substrate 1010.

At clock tree synthesis operation 223, the APR tool performs clock tree synthesis on the layout diagram 904 to generate a layout diagram 223L. For example, during the optimization process within the clock tree synthesis, the APR tool may insert one or more clock buffers 1022 into the layout diagram 904 to achieve desired clock timing. At PDN refinement operation 243, the processor 102 may execute the machine-learning model 1045 to perform an inference process (e.g., a second inference process) using the layout diagram 223L to generate a layout diagram 906 with an adaptive backside PDN, as shown in FIGS. 10C-1 to 10C-3. For example, referring to FIG. 10C-1, which is a top perspective view of the layout diagram 906, metal wires 1031 of the frontside routing network are disposed on the frontside 1010s1 of the semiconductor substrate 1010. Referring to FIG. 10C-2, which is a bottom perspective view of the layout diagram 906, the metal wires 1001B of the backside PDN are disposed on the backside 1010s2 of the semiconductor substrate 1010. Additionally, the locations and distribution of the metal wires 1001B of the backside PDN within the layout diagram 906 in FIG. 10C-2 are different from those within the layout diagram 906 in FIG. 10B-2. Referring to FIG. 10C-3, which is a side view of the layout diagram 906, it can be seen that the locations and distribution of the metal wires 1001B of the backside PDN within the layout diagram 906 in FIG. 10C-2 are different from those within the layout diagram 906 in FIG. 10B-2.

At routing operation 224, the APR tool performs routing to route various nets (e.g., metal wires 831) interconnecting the placed standard cells 1020 and clock buffers 1022 within the layout diagram 906 to generate a layout diagram 224L. For example, the routing is performed to ensure that the routed interconnections or nets satisfy a set of constraints. At PDN refinement operation 244, the processor 102 may execute the machine-learning model 1045 to perform an inference process (e.g., a third inference process) using the layout diagram 224L to generate a layout diagram 908 with an adaptive frontside PDN, as shown in FIGS. 10D-1 to 10D-3. Routing operation 224 and PDN refinement operation 244 may alternate metal wires 1001B (e.g., backside PDN) within the layout diagram 906, resulting in the locations and distributions of metal wires 1001B and 1031 within the layout diagram 908 being different from those within the PDN of the layout diagram 906.

At post-routing optimization operation 225, the APR tool performs one or more physical and/or timing verifications on the layout diagram 908 to generate a layout diagram 225L. It should be noted that in order to solve the IR and timing issues of the layout diagram 225L, the APR tool may alternate the locations and distribution of standard cells 1020, clock buffers 1022, and metal wires 1001B and 1031 within the layout diagram 908. As a result, the locations and distribution of standard cells 1020, clock buffers 1022, and metal wires 1001B and 1031 within the layout diagram 225L can be different from those within the layout diagram 908. Similarly, the backside PDN within the layout diagram 225L generated by post-routing optimization operation 225 is further refined by PDN refinement operation 245. At PDN refinement operation 245, the processor 102 may execute the machine-learning model 1045 to perform yet another inference process (e.g., fourth inference process) using the layout diagram 225L to generate a layout diagram 910 with an adaptive backside PDN, which may be a signed-off layout diagram to be passed to manufacturing. For brevity, the layout diagram 910, which is similar to the layout diagram 908 in FIGS. 10D-1 to 10D-3, is not explicitly shown.

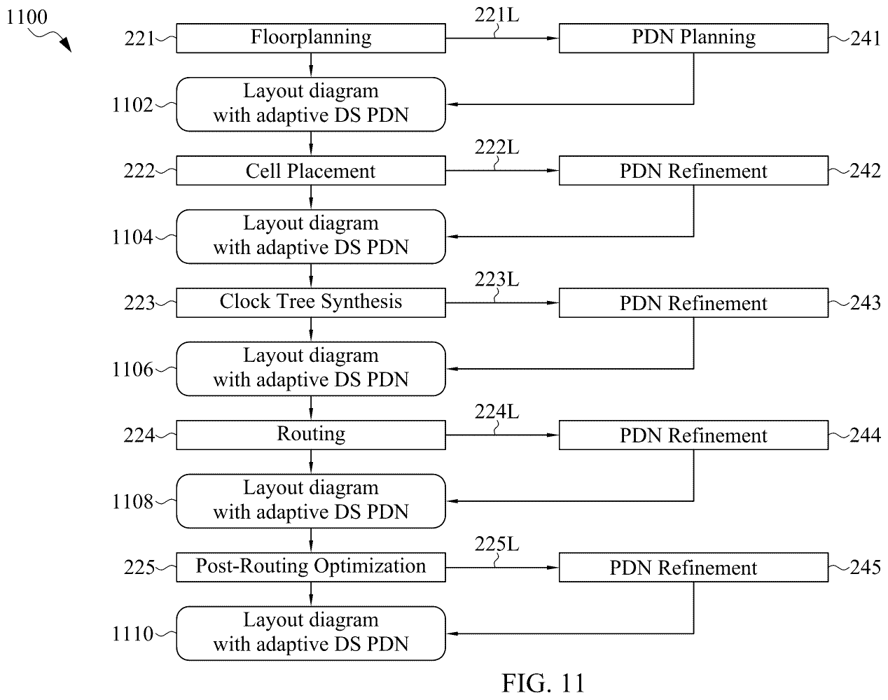

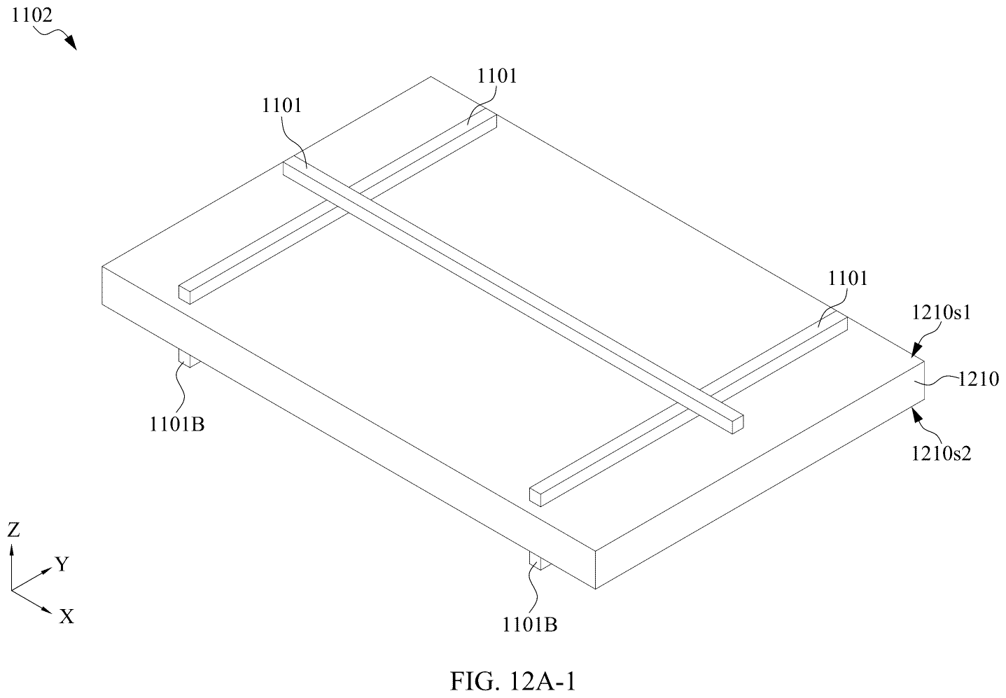

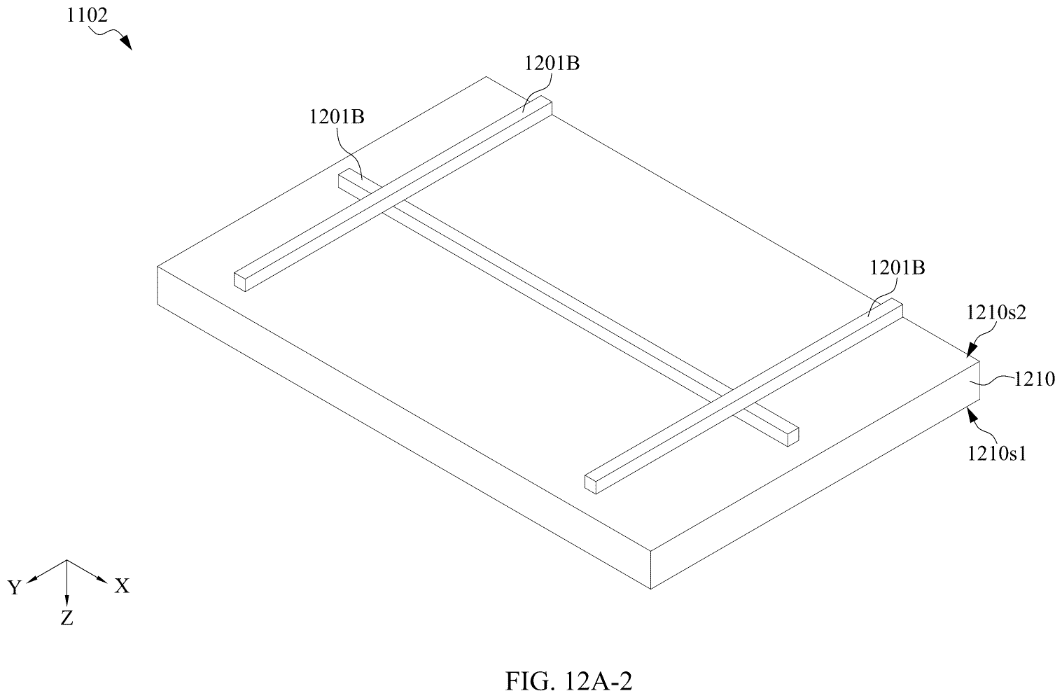

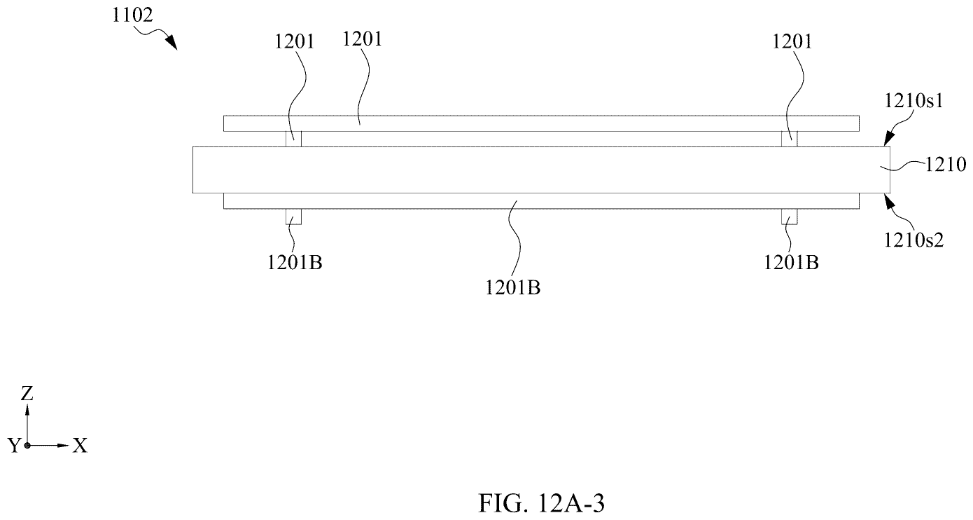

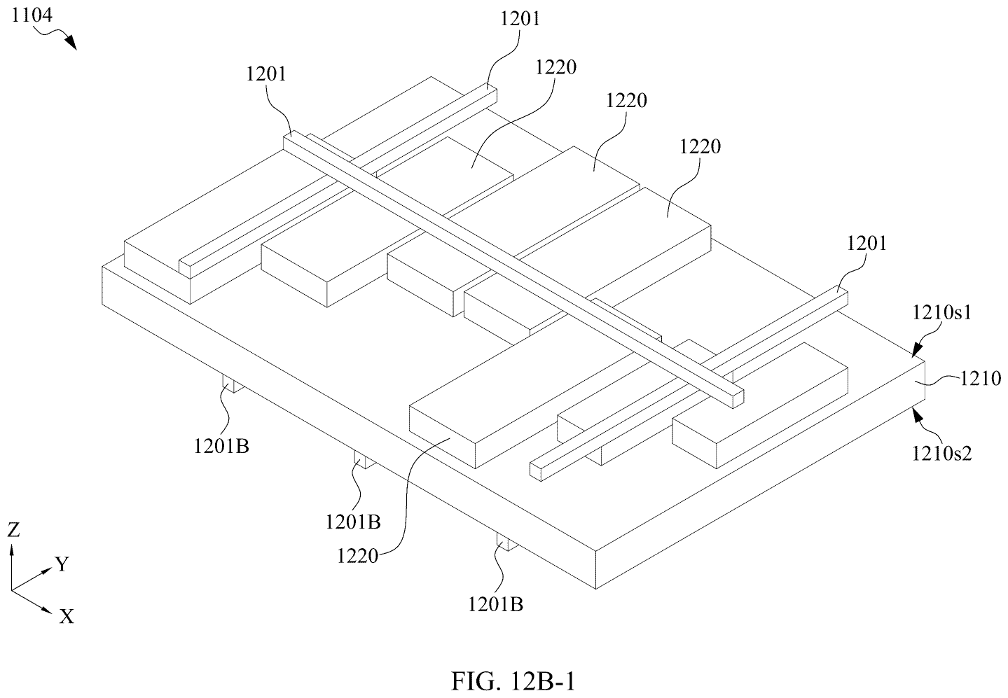

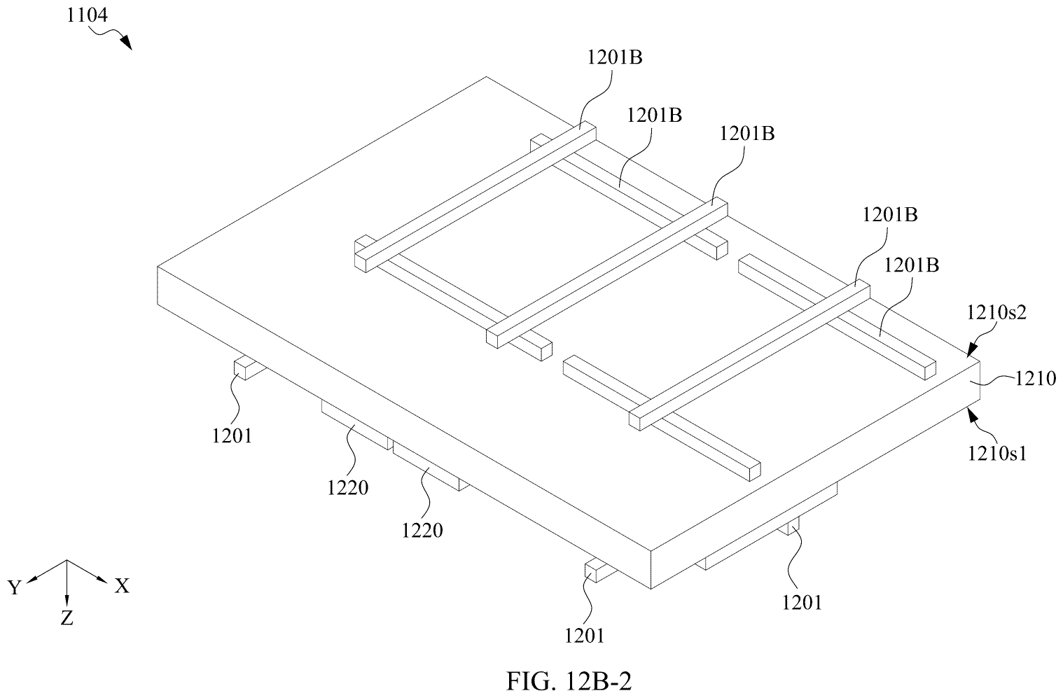

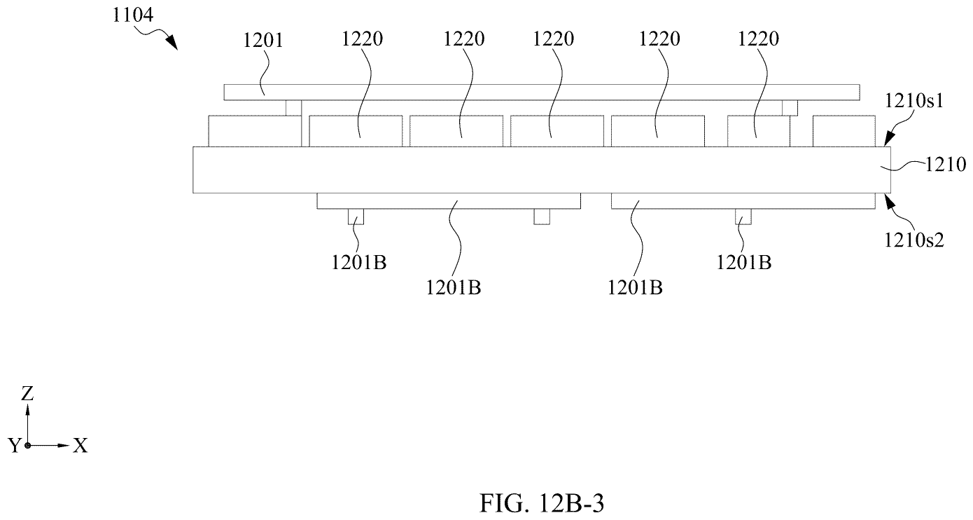

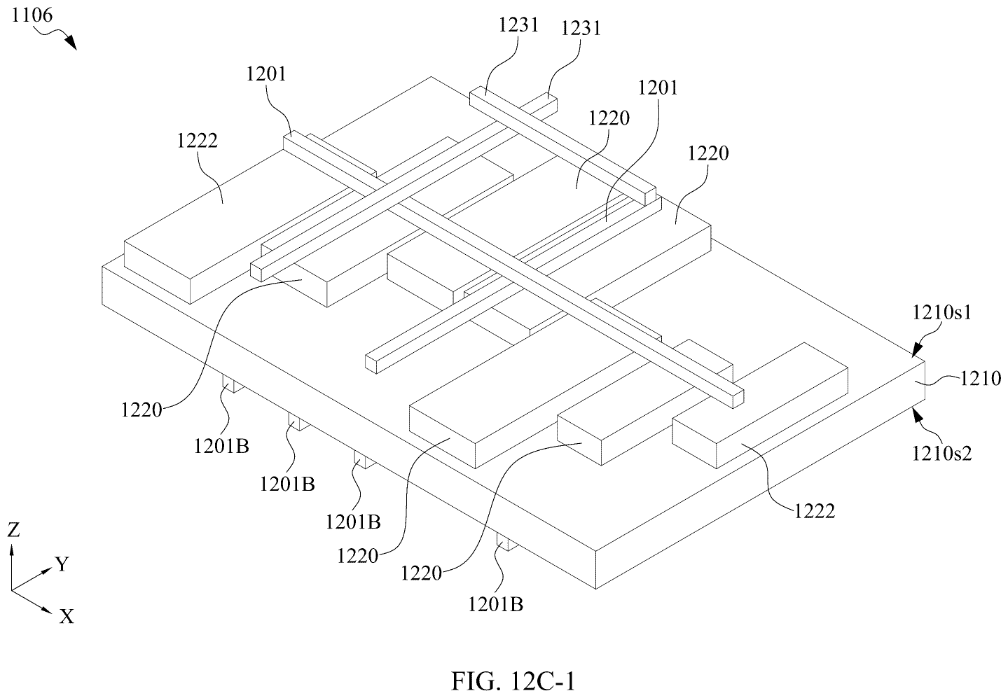

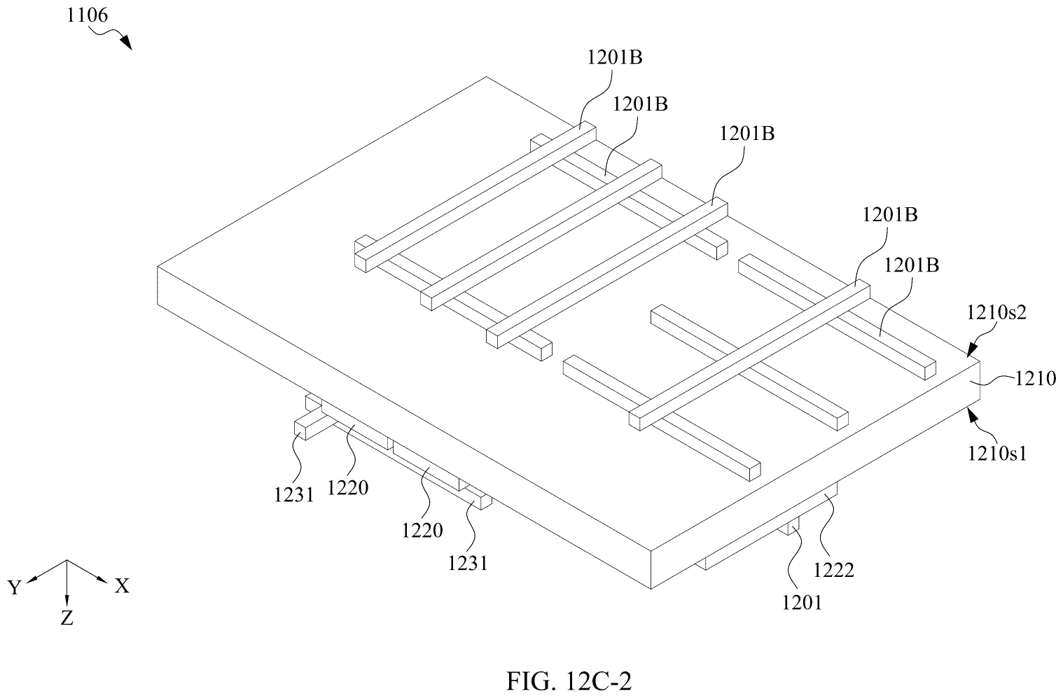

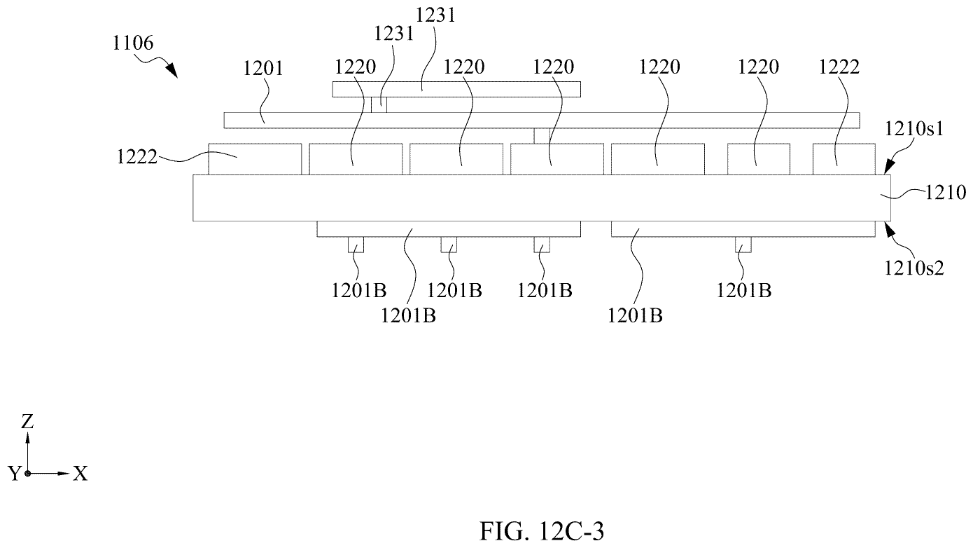

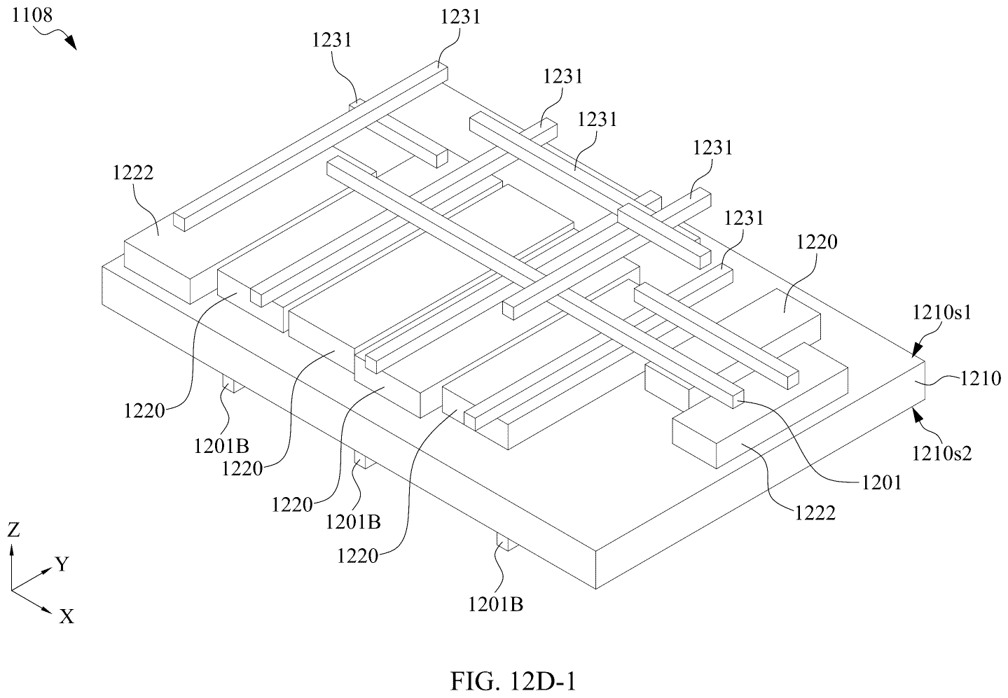

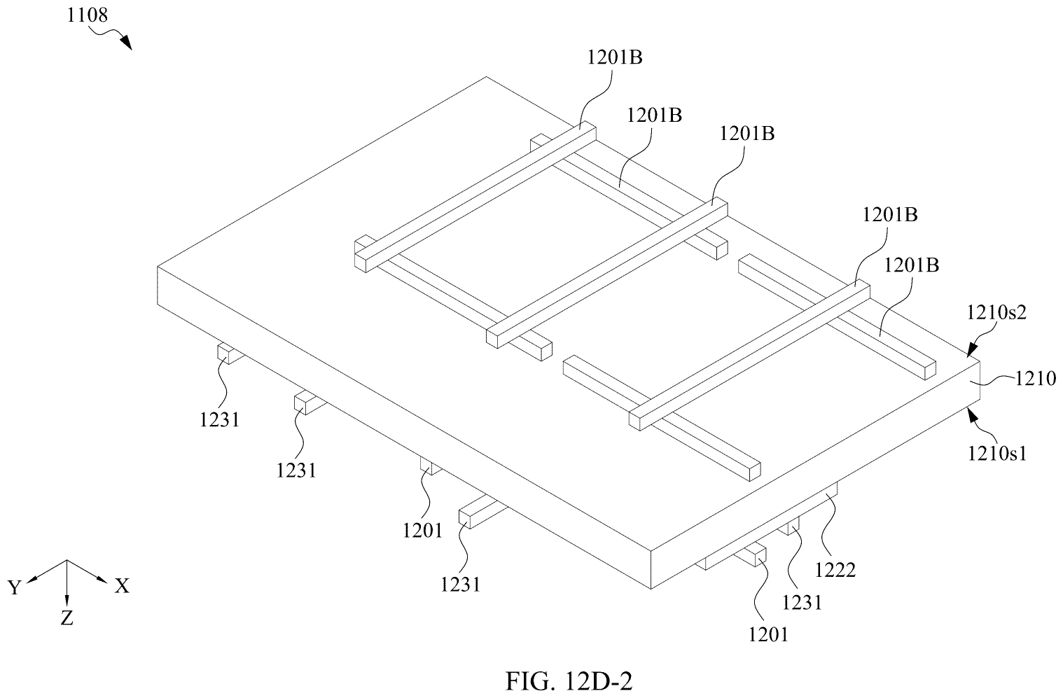

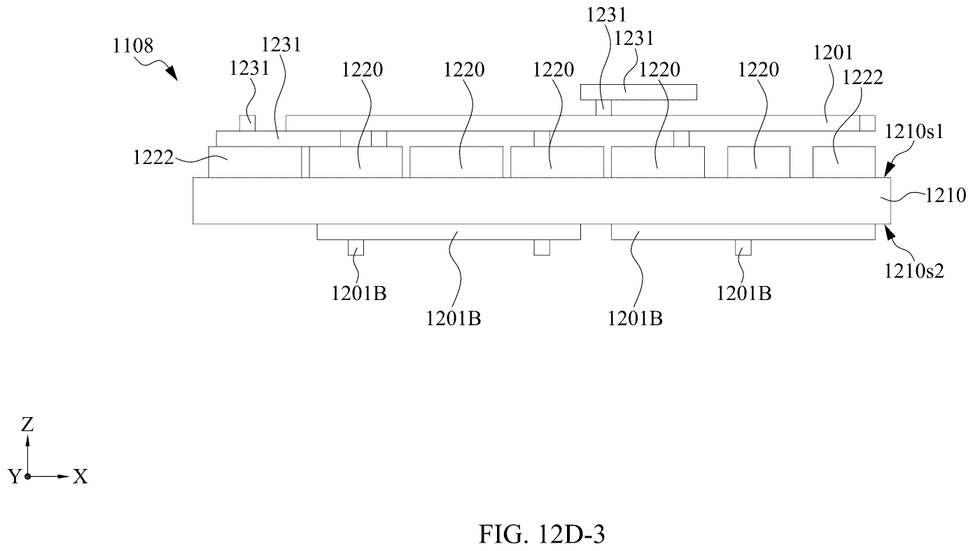

FIG. 11 is a flowchart of the procedure of constructing an adaptive dual-side PDN within an IC layout diagram during various operations in an APR process in accordance with some embodiments of the present disclosure. FIGS. 12A to 12D are different perspective views of layout diagrams during different operations in flow 1100 of FIG. 11.

In some embodiments, flow 1100 shown in FIG. 11 may be similar to flow 200 shown in FIG. 2, with the difference being that flow 1100 is particularly for constructing an adaptive dual-side (DS) PDN, which includes a frontside PDN and a backside PDN, within an IC layout diagram. For example, each of operations 222 to 225 is followed by a respective PDN refinement operation (e.g., operations 242 to 245) for the dual-side PDN.

At floorplanning operation 221, the APR tool may perform floorplanning on an input IC design (e.g., an IC schematic) to generate a layout diagram 221L, such as a semiconductor substrate 1210 shown in FIG. 12A-1. At PDN planning operation 241, the APR tool or the machine-learning model 1045 performs power planning based on the partitioning and/or the floorplan of the layout diagram 221L to generate a layout diagram 1102 with an initial dual-side power delivery network, which includes metal wires 1201 and 1201B. In some embodiments, the initial dual-side power delivery network, which is in either a sparse type or a dense type, can be disposed on both the frontside 1210s1 and backside 1210s2 of the semiconductor substrate 1210, depending on the predefined settings of the APR tool. For brevity, the initial dual-side power delivery network is a sparse PDN, as shown in FIGS. 12A-1 to 12A-3. For example, referring to FIG. 12A-1, which is a top perspective view of the layout diagram 1102, metal wires 1201 (i.e., frontside PDN) are disposed on the frontside 1210s1 of the semiconductor substrate 1210. Referring to 12A-2, which is a bottom perspective view of the layout diagram 1102, metal wires 1201B (i.e., backside PDN) are disposed on the backside 1201s2 of the semiconductor substrate 1210. Referring to 12A-3, which is a side view of the layout diagram 1102, it can be seen that the metal wires 1201 and 1201B are disposed on the frontside 1210s1 and backside 1210s2 of the semiconductor substrate 1210, respectively.

At cell placement operation 222, the APR tool places one or more standard cells 1220 on the frontside 1210s1 of the semiconductor substrate 1210 to generate a layout diagram 222L. At PDN refinement operation 242, the processor 102 may execute the machine-learning model 1045 to perform an inference process (e.g., first inference process) using the layout diagram 222L to generate a layout diagram 1104 with an adaptive dual-side PDN, as shown in FIGS. 12B-1 to 12B-3. For example, referring to FIG. 12B-1, which is a top perspective view of the layout diagram 1104, the standard cells 1220 and metal wires 1201 are disposed on the frontside 1210s1 of the semiconductor substrate 1210. Referring to FIG. 12B-2, which is a bottom perspective view of the layout diagram 1104, the metal wires 1201B of the backside PDN are disposed on the backside 1210s2 of the semiconductor substrate 1210. Referring to FIG. 12B-3, which is a side view of the layout diagram 1104, it can be seen that the metal wires 1201 and metal wires 1201B are disposed on opposite sides (i.e., frontside 1210s1 and backside 1210s2) of the semiconductor substrate 1210. It should be noted that the locations and distribution of the frontside PDN (e.g., metal wires 1201) and backside PDN (e.g., metal wires 1201B) in FIGS. 12B-1 and 12B-2 are different from those in FIGS. 12A-1 and 12A-2 since both the frontside PDN and backside PDN are refined by PDN refinement operation 242 (e.g., replacing the frontside PDN and backside PDN with the inferenced adaptive frontside PDN and inferenced adaptive backside PDN, respectively).

At clock tree synthesis operation 223, the APR tool performs clock tree synthesis on the layout diagram 1104 to generate a layout diagram 223L. For example, during the optimization process within the clock tree synthesis, the APR tool may insert one or more clock buffers 1022 into the layout diagram 1104 to achieve desired clock timing. At PDN refinement operation 243, the processor 102 may execute the machine-learning model 1045 to perform an inference process (e.g., a second inference process) using the layout diagram 223L to generate a layout diagram 1106 with an adaptive dual-side PDN, as shown in FIGS. 12C-1 to 12C-3. For example, referring to FIG. 12C-1, which is a top perspective view of the layout diagram 1106, metal wires 1231 of the frontside routing network, along with standard cells 1220 and metal wires 1201, are disposed on the frontside 1210s1 of the semiconductor substrate 1210. Referring to FIG. 12C-2, which is a bottom perspective view of the layout diagram 1106, the metal wires 1201B of the backside PDN are disposed on the backside 1210s2 of the semiconductor substrate 1210. Referring to FIG. 12C-3, which is a side view of the layout diagram 1106, it can be seen that the locations and distribution of the metal wires 1201 (e.g., frontside PDN) and metal wires 1201B (e.g., backside PDN) within the layout diagram 1106 in FIGS. 12C-1 to 12C-3 are different from those within the layout diagram 1106 in FIGS. 12B-1 to 12B-3.

At routing operation 224, the APR tool performs routing to route various nets (e.g., metal wires 1231) interconnecting the placed standard cells 1220 and clock buffers 1222 within the layout diagram 1106 to generate a layout diagram 224L. For example, the routing is performed to ensure that the routed interconnections or nets satisfy a set of constraints. At PDN refinement operation 244, the processor 102 may execute the machine-learning model 1045 to perform an inference process (e.g., a third inference process) using the layout diagram 224L to generate a layout diagram 1108 with an adaptive dual-side PDN, as shown in FIGS. 12D-1 to 12D-3. Routing operation 224 and PDN refinement operation 244 may alternate metal wires 1201 (e.g, frontside PDN) and 1201B (e.g., backside PDN) within the layout diagram 1106, resulting in the locations and distributions of metal wires 1201 and 1201B within the layout diagram 1108 being different from those within layout diagram 1106.

At post-routing optimization operation 225, the APR tool performs one or more physical and/or timing verifications on the layout diagram 1108 to generate a layout diagram 225L. It should be noted that in order to solve the IR and timing issues of the layout diagram 225L, the APR tool may alternate the locations and distribution of standard cells 1220, clock buffers 1222, and metal wires 1201, 1201B and 1231 within the layout diagram 1108. As a result, the locations and distribution of standard cells 1220, clock buffers 1222, and metal wires 1201, 1201B and 1231 within the layout diagram 225L can be different from those within the layout diagram 1108. Similarly, the dual-side PDN within the layout diagram 225L generated by post-routing optimization operation 225 is further refined by PDN refinement operation 245. At PDN refinement operation 245, the processor 102 may execute the machine-learning model 1045 to perform yet another inference process (e.g., fourth inference process) using the layout diagram 225L to generate a layout diagram 1210F with an adaptive dual-side PDN, which may be a signed-off layout diagram to be passed to manufacturing. For brevity, the layout diagram 1210F, which is similar to the layout diagram 1108 in FIGS. 12D-1 to 12D-3, is not explicitly shown.

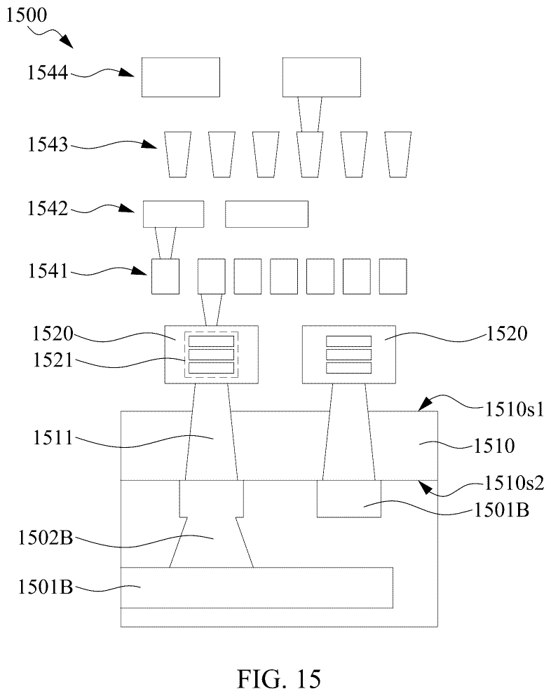

In some embodiments, semiconductor structure 1500 shown in FIG. 15 can be employed in the backside PDN (e.g., metal wires 1001B) of the layout diagrams FIGS. 10B to 10D and 12A to 12D. A technique called “backside direct contact” can be applied to semiconductor structure 1500. For example, the backside PDN may include metal layer 1501B which is disposed on the backside 1510s2 of semiconductor substrate 1510. Metal layer 1501B can be electrically connected to a source/drain region (e.g., S/D region) 1521 of standard cells 1520, which are disposed on the frontside 1510s1 of semiconductor substrate 1510, through backside contacts 1511. Specifically, the backside contacts 1511 can penetrate semiconductor substrate 1510 from the backside 1510s2 of semiconductor substrate 1510 directly to the S/D region 1521 of standard cells 1520, reducing the vertical distance from the backside PDN to the standard cells on the frontside 1510s1. This allows power on the backside PDN (e.g., metal wires 1501B and via 1502B) to be delivered directly to the S/D region 1521 of standard cells 1520, reducing unnecessary power dissipation caused by the power path.

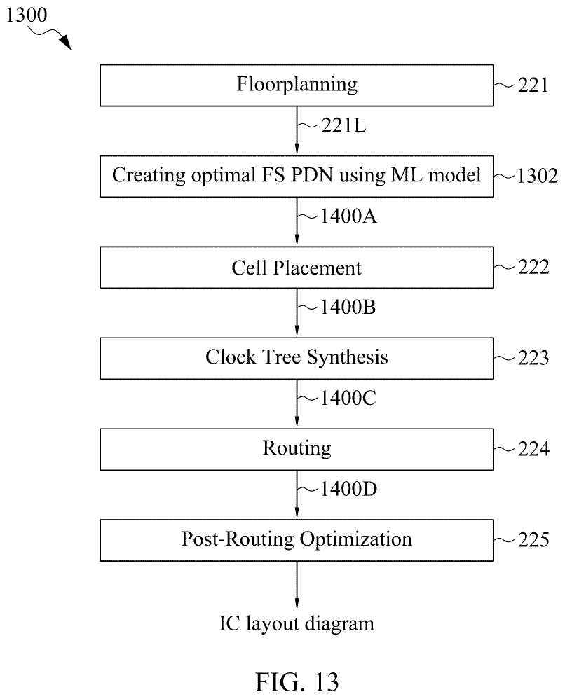

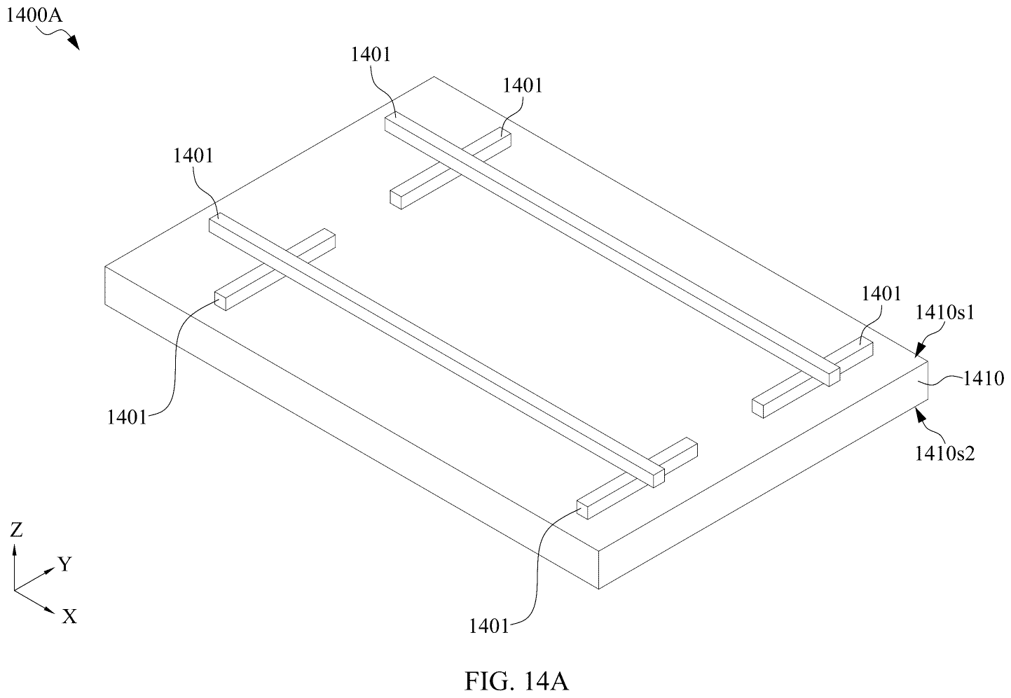

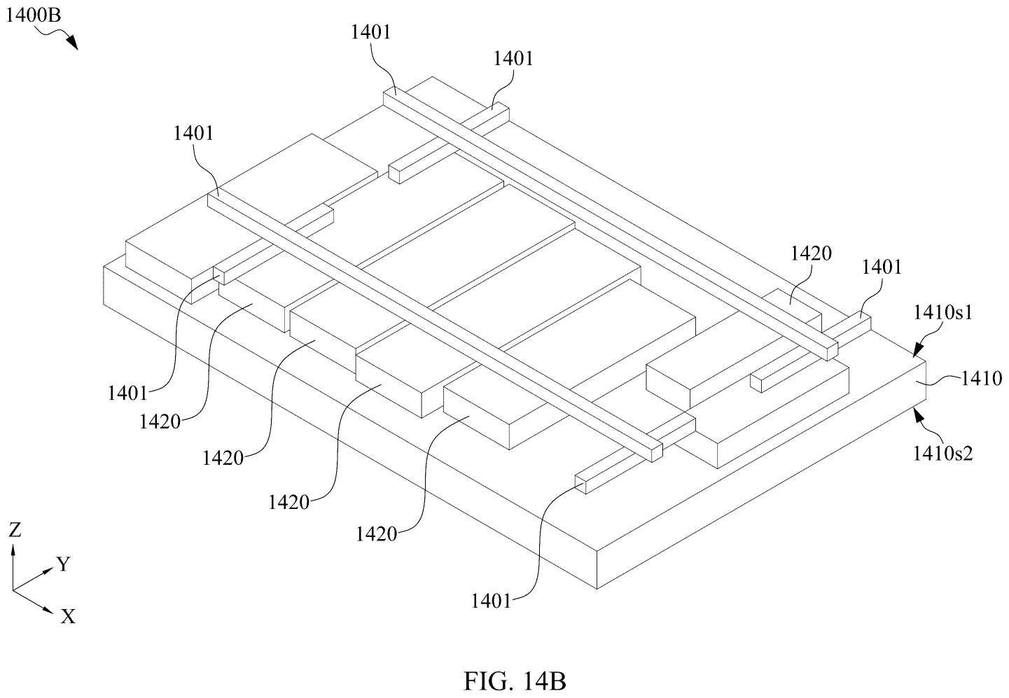

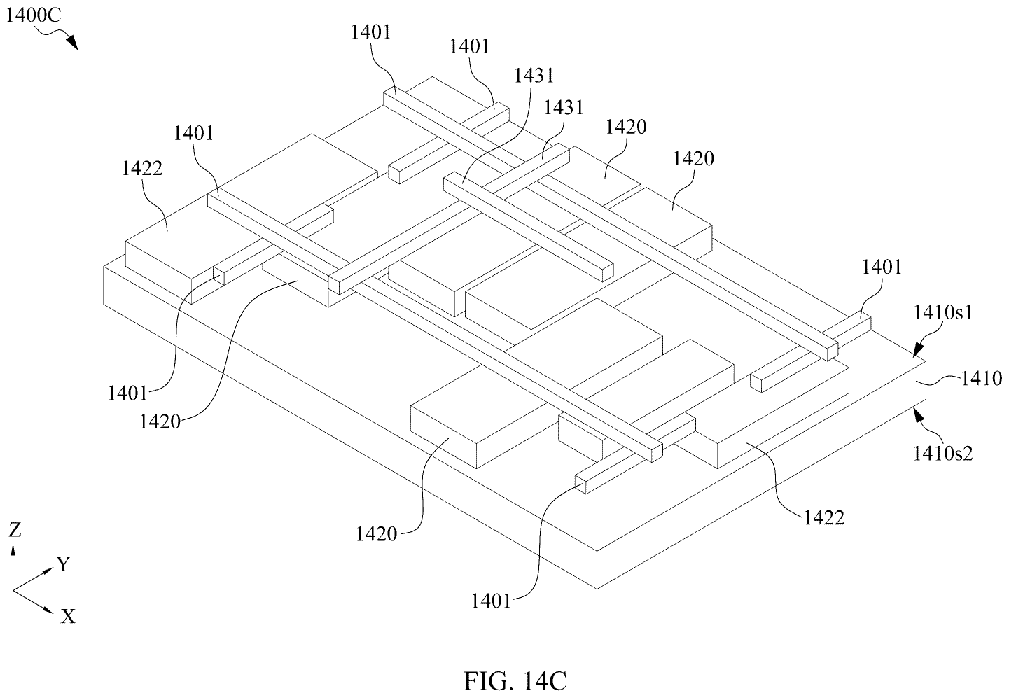

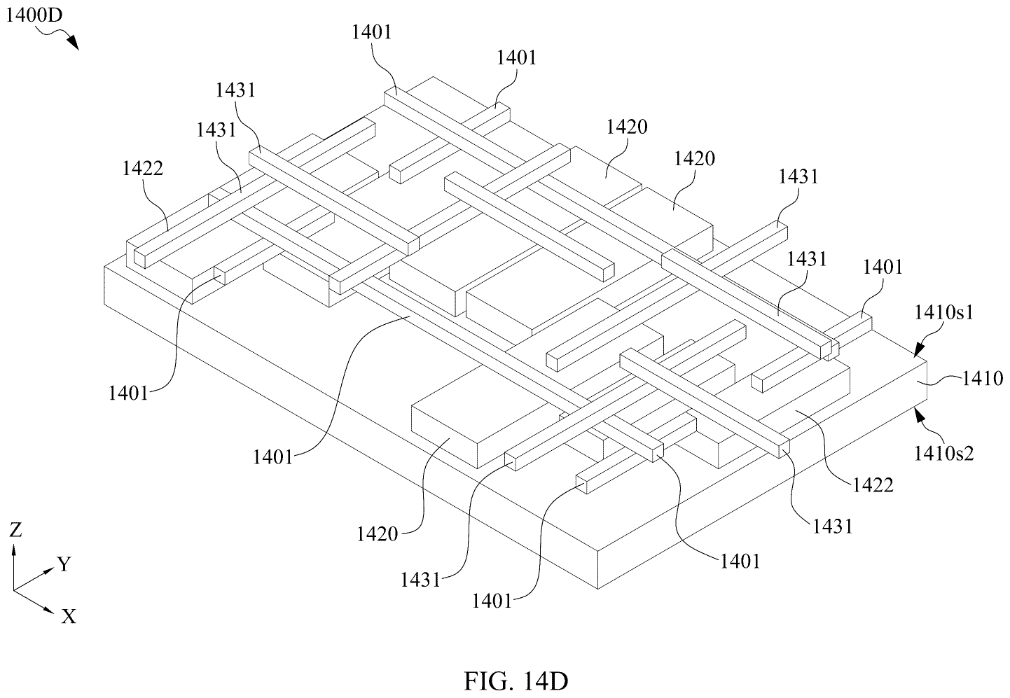

FIG. 13 is a flowchart of the procedure of constructing an optimal frontside PDN within an IC layout diagram in an APR process in accordance with some embodiments of the present disclosure. FIGS. 14A to 14D are different perspective views of layout diagrams during different operations in flow 1300 of FIG. 13.

In some embodiments, flow 1300 shown in FIG. 13 may be similar to flow 200 shown in FIG. 2, with the difference being that flow 1300 is particularly for constructing an optimal frontside (FS) PDN within an IC layout diagram. For example, the optimal frontside PDN can be created using the machine-learning model 1046 based on a plurality of design parameters of an IC layout diagram.

At floorplanning operation 221, the APR tool may generate a layout diagram 221L for an input netlist of an IC design, such as a semiconductor substrate 1410 shown in FIG. 14A. At operation 1302, the machine-learning model 1046 may create, using a plurality of design parameters of the input IC design netlist, an optimal frontside power delivery network on the frontside 1410s1 of the semiconductor substrate 1410 to generate a layout diagram 1400A, as shown in FIG. 14A. In some embodiments, the optimal frontside power delivery network, which can be either dense or sparse, may be disposed on the frontside 810s1 of the semiconductor substrate 810, depending on the determination result of the machine-learning model 1046. For purposes of description, the optimal frontside power delivery network shown in FIG. 14A, which includes metal wires 1401, is a sparse frontside PDN.

In some embodiments, the design parameters may include, but are not limited to, the cell composition of the input netlist, and operating frequency and design style of the IC design. For example, the cell composition may refer to the types of standard cells within the input netlist, which may include, but are not limited to, AOI22 (e.g., and-or-invert gate), OAI22 (e.g., or-and-invert gate), ND2 (e.g., NAND gatc), NR2 (e.g., NOR), INV (e.g., inverter), BUFF (e.g., buffer), SDF (e.g., scan D flip-flop), etc. In some embodiments, high usage of AOI22 or OAI22 cells within the input netlist may indicate that pin accesses and routing for the IC design corresponding to the input netlist can be challenging. Additionally, high usage of ND2, NR2, INV, and BUFF cells within the input netlist may indicate that pin accesses and routing for the IC design corresponding to the input netlist can be easier.

In some embodiments, the structure or type of the PDN of the IC layout diagram 1400A may be associated with the operating frequency of the IC design. For example, a higher operating frequency the IC design uses, higher power consumption the cells use. In other words, when the operating frequency of the IC design is very high, it indicates that the machine-learning model 1046 may be more likely to use the dense PDN structure. On the other hand, when the operating frequency of the IC design is low, it indicates that the machine-learning model 1046 may be more likely to use the sparse PDN structure.

In some embodiments, the structure or type of the PDN of the IC layout diagram 1400A may be associated with the design style of the IC design. For design styles with heavy data access rates, such as CPU, GPU, NPC, etc., the standard cells within the IC layout diagram may consume more power. Thus, the machine-learning model 1046 may be more likely to use the dense PDN structure in this situation. For the design styles with lighter data access rates, the machine-learning model 1046 may be more likely to use the sparse frontside PDN structure in this situation.

Specifically, the training data for the machine-learning model 1046 may include a plurality of netlist of IC designs, and operating frequencies and design styles of these IC designs. Additionally, the PDN structures of signed-off layout diagrams of these IC designs can be the labels for the training data. Accordingly, the trained machine-learning model 1046 may be capable of predicting or determining the most appropriate PDN structure (e.g., sparse or dense) using a netlist of a given IC design. In some embodiments, the PDN structures of the frontside PDN in different metal layers (e.g., M0 to Mtop shown in FIG. 5) can be different. Details of the PDN structures can be referred to the embodiments of FIGS. 4A to 4J, and thus will not be repeated here.

In some embodiments, the machine-learning model 1046 can also be a K-nearest neighbors (KNN) model or any other classification machine-learning models, but the present disclosure is not limited thereto.

At cell placement operation 222, the APR tool places one or more standard cells 1420 on the frontside 1410s1 of the semiconductor substrate 1410 to generate a layout diagram 1400B. For example, the standard cells 1420 configured to provide pre-defined functions and having pre-designed layout diagrams are stored in cell library 1044.

At clock tree synthesis operation 223, the APR tool performs clock tree synthesis on the layout diagram 1400B to generate a layout diagram 1400C. For example, during the optimization process within the clock tree synthesis, the APR tool may insert one or more clock buffers 1422 into the layout diagram 1400B to achieve desired clock timing.

At routing operation 224, the APR tool performs routing to route various nets (e.g., metal wires 731) interconnecting the placed standard cells 1420 and clock buffers 1422 within the layout diagram 1400C to generate a layout diagram 1400D. For example, the routing is performed to ensure that the routed interconnections or nets satisfy a set of constraints. It should be noted that the location and distribution of the PDNs (e.g., metal wires 1401) within the IC layout diagrams 1400A, 1400B, 1400C, and 1400D remain unchanged during flow 1400.

At post-routing optimization operation 225, the APR tool performs one or more physical and/or timing verifications on the layout diagram 1400D to generate an output IC layout diagram. It should be noted that in order to solve the IR and timing issues of the output layout diagram, the APR tool may alternate the locations and distribution of standard cells 1420, clock buffers 1422, metal wires 1401 and 1431 within the layout diagram 1400D. As a result, the locations and distribution of standard cells 1420, clock buffers 1422, metal wires 1401 and 1431 within the output IC layout diagram can be different from those within the layout diagram 1400D. For brevity, the output IC layout diagram, which is similar to the layout diagram 1400D in FIG. 14D, is not explicitly shown. Furthermore, the output IC layout diagram generated by the APR process (e.g., flow 1300) can be used to fabricate an integrated circuit in a foundry.

FIG. 16 is a block diagram of an IC manufacturing system 1600, and an IC manufacturing flow associated therewith, in accordance with some embodiments. In some embodiments, based on an IC layout diagram, at least one of (A) one or more semiconductor masks or (B) at least one component in a layer of a semiconductor integrated circuit is fabricated using manufacturing system 1600.

In FIG. 16, IC manufacturing system 1600 includes entities, such as a design house 1620, a mask house 1630, and an IC manufacturer/fabricator (“fab”) 1650, that interact with one another in the design, development, and manufacturing cycles and/or services related to manufacturing an IC device 1660. The entities in system 1600 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of design house 1620, mask house 1630, and IC fab 1650 is owned by a single larger company. In some embodiments, two or more of design house 1620, mask house 1630, and IC fab 1650 coexist in a common facility and use common resources.

Design house (or design team) 1620 generates an IC design layout diagram 1622. IC design layout diagram 1622 includes various geometrical patterns, e.g., an IC layout diagram discussed above. The geometrical patterns correspond to patterns of metal, oxide, or semiconductor layers that make up the various components of IC device 1660 to be fabricated. The various layers combine to form various IC features. For example, a portion of IC design layout diagram 1622 includes various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate. Design house 1620 implements a proper design procedure to form IC design layout diagram 1622. The design procedure includes one or more of logic design, physical design or place and route. IC design layout diagram 1622 is presented in one or more data files having information of the geometrical patterns. For example, IC design layout diagram 1622 can be expressed in a GDSII file format or DFII file format.

Mask house 1630 includes data preparation 1632 and mask fabrication 1644. Mask house 1630 uses IC design layout diagram 1622 to manufacture one or more masks 1645 to be used for fabricating the various layers of IC device 1660 according to IC design layout diagram 1622. Mask house 1630 performs mask data preparation 1632, where IC design layout diagram 1622 is translated into a representative data file (RDF). Mask data preparation 1632 provides the RDF to mask fabrication 1644. Mask fabrication 1644 includes a mask writer. A mask writer converts the RDF to an image on a substrate, such as mask (reticle) 1645 or a semiconductor wafer 1653. The design layout diagram 1622 is manipulated by mask data preparation 1632 to comply with particular characteristics of the mask writer and/or requirements of IC fab 1650. In FIG. 16, mask data preparation 1632 and mask fabrication 1644 are illustrated as separate elements. In some embodiments, mask data preparation 1632 and mask fabrication 1644 can be collectively referred to as mask data preparation.

In some embodiments, mask data preparation 1632 includes optical proximity correction (OPC) which uses lithography enhancement techniques to compensate for image errors, such as those that can arise from diffraction, interference, other process effects and the like. OPC adjusts IC design layout diagram 1622. In some embodiments, mask data preparation 1632 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, mask data preparation 1632 includes a mask rule checker (MRC) that checks the IC design layout diagram 1622 that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout diagram 1622 to compensate for limitations during mask fabrication 1644, which may undo part of the modifications performed by OPC in order to meet mask creation rules.

In some embodiments, mask data preparation 1632 includes lithography process checking (LPC) that simulates processing that will be implemented by IC fab 1650 to fabricate IC device 1660. LPC simulates this processing based on IC design layout diagram 1622 to create a simulated manufactured device, such as IC device 1660. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (“DOF”), mask error enhancement factor (“MEEF”), other suitable factors, and the like or combinations thereof. In some embodiments, after a simulated manufactured device has been created by LPC, if the simulated device is not close enough in shape to satisfy design rules, OPC and/or MRC are be repeated to further refine IC design layout diagram 1622.

It should be understood that the above description of mask data preparation 1632 has been simplified for the purposes of clarity. In some embodiments, data preparation 1632 includes additional features such as a logic operation (LOP) to modify the IC design layout diagram 1622 according to manufacturing rules. Additionally, the processes applied to IC design layout diagram 1622 during data preparation 1632 may be executed in a variety of different orders.

After mask data preparation 1632 and during mask fabrication 1644, a mask 1645 or a group of masks 1645 are fabricated based on the modified IC design layout diagram 1622. In some embodiments, mask fabrication 1644 includes performing one or more lithographic exposures based on IC design layout diagram 1622. In some embodiments, an electron-beam (e-beam) or a mechanism of multiple e-beams is used to form a pattern on a mask (photomask or reticle) 1645 based on the modified IC design layout diagram 1622. Mask 1645 can be formed in various technologies. In some embodiments, mask 1645 is formed using binary technology. In some embodiments, a mask pattern includes opaque regions and transparent regions. A radiation beam, such as an ultraviolet (UV) or EUV beam, used to expose the image sensitive material layer (e.g., photoresist) which has been coated on a wafer, is blocked by the opaque region and transmits through the transparent regions. In one example, a binary mask version of mask 1645 includes a transparent substrate (e.g., fused quartz) and an opaque material (e.g., chromium) coated in the opaque regions of the binary mask. In another example, mask 1645 is formed using a phase shift technology. In a phase shift mask (PSM) version of mask 1645, various features in the pattern formed on the phase shift mask are configured to have proper phase difference to enhance the resolution and imaging quality. In various examples, the phase shift mask can be attenuated PSM or alternating PSM. The mask(s) generated by mask fabrication 1644 is used in a variety of processes. For example, such a mask(s) is used in an ion implantation process to form various doped regions in semiconductor wafer 1653, in an etching process to form various etching regions in semiconductor wafer 853, and/or in other suitable processes.

IC fab 1650 is an IC fabrication business that includes one or more manufacturing facilities for the fabrication of a variety of different IC products. In some embodiments, IC Fab 1650 is a semiconductor foundry. For example, there may be a manufacturing facility for the front end fabrication of a plurality of IC products (front-end-of-line (FEOL) fabrication), while a second manufacturing facility may provide the back end fabrication for the interconnection and packaging of the IC products (back-end-of-line (BEOL) fabrication), and a third manufacturing facility may provide other services for the foundry business.

IC fab 1650 includes wafer fabrication tools 1652 configured to execute various manufacturing operations on semiconductor wafer 1653 such that IC device 1660 is fabricated in accordance with the mask(s), e.g., mask 1645. In various embodiments, fabrication tools 1652 include one or more of a wafer stepper, an ion implanter, a photoresist coater, a process chamber, e.g., a CVD chamber or LPCVD furnace, a CMP system, a plasma etch system, a wafer cleaning system, or other manufacturing equipment capable of performing one or more suitable manufacturing processes as discussed herein.

IC fab 1650 uses mask(s) 1645 fabricated by mask house 1630 to fabricate IC device 1660. Thus, IC fab 1650 at least indirectly uses IC design layout diagram 1622 to fabricate IC device 1660. In some embodiments, semiconductor wafer 1653 is fabricated by IC fab 1650 using mask(s) 1645 to form IC device 1660. In some embodiments, the IC fabrication includes performing one or more lithographic exposures based at least indirectly on IC design layout diagram 1622. Semiconductor wafer 1653 includes a silicon substrate or other proper substrate having material layers formed thereon. Semiconductor wafer 1653 further includes one or more of various doped regions, dielectric features, multilevel interconnects, and the like (formed at subsequent manufacturing steps).

An aspect of the present disclosure provides a method, which includes the following steps: obtaining a netlist of an integrated circuit (IC) design; performing an automatic placement and routing (APR) process on the netlist to generate a result layout diagram; and during each operation with the APR process, refining, using a machine-learning model, a power delivery network within a layout diagram generated at each operation within the APR process.

Another aspect of the present disclosure provides a method, which includes the following steps: obtaining a netlist of an integrated circuit (IC) design; performing an automatic placement and routing (APR) process on the netlist to generate a result layout diagram; and during each operation with the APR process, partitioning a layout diagram generated at each operation within the APR process into a plurality of grids, and adaptively updating, using a machine-learning model, a power delivery network of the layout diagram on a grid basis according to a plurality of features of each grid.

Yet another aspect of the present disclosure provides a system, which includes a non-transitory computer-readable medium storing program instructions, and a processor operatively coupled to the non-transitory computer-readable medium. The program instructions, when executed by the processor, cause the processor to perform the following operations: obtaining a netlist of an integrated circuit (IC) design; and determining, using a machine-learning model, whether a power delivery network within a layout diagram corresponding to the IC design generated by an automatic placement and routing (APR) process is either in a first type or a second type based on a plurality of features of the IC design.

The methods and features of the present disclosure have been sufficiently described in the provided examples and descriptions. It should be understood that any modifications or changes without departing from the spirit of the present disclosure are intended to be covered in the protection scope of the present disclosure.

Moreover, the scope of the present application is not intended to be limited to the particular embodiments of the process, machine, manufacture, and composition of matter, means, methods and steps described in the specification. As those skilled in the art will readily appreciate from the present disclosure, processes, machines, manufacture, composition of matter, means, methods or steps presently existing or later to be developed, that perform substantially the same function or achieve substantially the same result as the corresponding embodiments described herein, can be utilized according to the present disclosure.

Accordingly, the appended claims are intended to include within their scope processes, machines, manufacture, compositions of matter, means, methods or steps. In addition, each claim constitutes a separate embodiment, and the combination of various claims and embodiments are within the scope of the present disclosure.

What is claimed is:

1. A method, comprising:
obtaining a netlist of an integrated circuit (IC) design; and
performing a plurality of operations of an automatic placement and routing (APR) process;
generating a layout diagram with a power delivery network upon completion of each operation of the APR process; and
adjusting a portion of the power delivery network of the layout diagram using a machine-learning model by inputting a plurality of features of the layout diagram generated at the respective operations of the APR process to the machine-learning model.

2. The method of claim 1, wherein adjusting a portion of the power delivery network of the layout diagram comprises: adjusting arrangement and/or a density of the portion of the power delivery network of the layout diagram.

3. The method of claim 1, further comprising:
generating a first layout diagram based on the netlist of the IC design at a floorplanning operation within the APR process; and
disposing an initial power delivery network on a semiconductor substrate within the first layout diagram to generate a refined first layout diagram.

4. The method of claim 3, further comprising:
placing a plurality of standard cells on the semiconductor substrate within the refined first layout diagram at a cell placement operation within the APR process to generate a second layout diagram; and
refining the initial power delivery network, using the machine-learning model, within the second layout diagram to generate a refined second layout diagram.

5. The method of claim 4, wherein the initial power delivery network and the standard cells are disposed on a first side of the semiconductor substrate.

6. The method of claim 4, wherein the standard cells and the initial power delivery network and are disposed on a first side and a second side opposite to the first side of the semiconductor substrate, respectively.

7. The method of claim 4, wherein:
the standard cells are disposed on a first side of the semiconductor substrate; and
the initial power delivery network comprises a first portion and a second portion, the first portion is disposed on the first side of the semiconductor substrate, and the second portion is disposed on a second side opposite to the first side of the semiconductor substrate.

8. The method of claim 4, further comprising
performing clock tree synthesis on the refined second layout diagram at a clock tree synthesis operation within the APR process to generate a third layout diagram; and
refining the power delivery network, using the machine-learning model, within the third layout diagram to generate a refined third layout diagram.

9. The method of claim 8, wherein one or more clock buffers are disposed on the semiconductor substrate within the refined second layout diagram during the clock tree synthesis operation.

10. The method of claim 9, further comprising:
routing a plurality of conductor wires interconnecting the placed standard cells at a routing operation within the APR process to generate a fourth layout diagram; and
refining the power delivery network, using the machine-learning model, within the fourth layout diagram to generate a refined fourth layout diagram.

11. The method of claim 10, wherein further comprising:
performing an optimization process on the refined fourth layout diagram at a post-routing optimization operation within the APR process to generate a fifth layout diagram; and
refining the power delivery network, using the machine-learning model, within the fourth layout diagram to generate a result layout diagram.

12. The method of claim 1, wherein refining, using the machine-learning model, the power delivery network within the layout diagram generated at each operation within the APR process comprises:
obtaining a plurality of maps associated with a plurality of predetermined traits of the layout diagram;
partitioning the layout diagram generated at each operation within the APR process into a plurality of grids;
extracting features of each grid within the layout diagram;
inferencing a power delivery network structure for each grid with in the layout diagram using the machine-learning model based on the extracted features of each grid to generate an adaptive power delivery network; and
replacing the power delivery network within the layout diagram with the generated adaptive power delivery network.

13. The method of claim 12, wherein the predetermined traits comprise a power density, cell driving, cell functionality, toggle rate, congestion, pin density, and timing critical path.

14. The method of claim 13, wherein the features of each grid comprise respective levels of the predetermined traits.

15. A method, comprising:
obtaining a netlist of an integrated circuit (IC) design;
performing an automatic placement and routing (APR) process on the netlist to generate a result layout diagram; and
during each operation within the APR process:
partitioning a layout diagram generated at each operation within the APR process into a plurality of grids of a fixed size; and
adaptively updating, using a machine-learning model, a power delivery network of the layout diagram on a grid basis by inputting a plurality of features of each grid within the layout diagram to the machine-learning model.

16. The method of claim 15, wherein the features of each grid comprise respective levels of a plurality of predetermined traits, and the predetermined traits comprise a power density, cell driving, cell functionality, toggle rate, congestion, pin density, and timing critical path of each grid.

17. The method of claim 15, wherein the power delivery network of the layout diagram is disposed on a first side, a second side opposite to the first side, or both the first side and the second side of a semiconductor substrate within the layout diagram.

18. A system, comprising a non-transitory computer-readable medium storing program instructions; and a processor operatively coupled to the non-transitory computer-readable medium, wherein the program instructions, when executed by the processor, cause the processor to perform:
obtaining a netlist of an integrated circuit (IC) design; and
determining, using a machine-learning model, whether a power delivery network within a layout diagram corresponding to the IC design generated by an automatic placement and routing (APR) process is either in a first type or a second type based on a plurality of features of the IC design; and
fabricating an integrated circuit using the layout diagram generated by the APR process.

19. The system of claim 18, wherein a density of conductive wires in the power delivery network of the first type is higher than that of the second type.

20. The system of claim 18, wherein the features of the IC design comprise cell composition of the netlist of the IC design, and an operating frequency and a design style of the IC design.
